(19) United States
(12) Patent Application Publication
(10) Pub. No.: US 2018/0020895 A1
(43) Pub. Date: Jan. 25, 2018

(54) ELECTRICAL GENERATOR SYSTEM FOR USE WITH VEHICLE MOUNTED ELECTRIC FLOOR CLEANING SYSTEM

(71) Applicants: Horace Kurt Betton, Ocoee, FL (US); Mark Wayne Baxter, Coeur d’ Alene, ID (US); Lance Ronal Joseph Koty, Marysville, WA (US); Christopher Isamu Ryan, Lynnwood, WA (US)

(72) Inventors: Horace Kurt Betton, Ocoee, FL (US); Mark Wayne Baxter, Coeur d’ Alene, ID (US); Lance Ronal Joseph Koty, Marysville, WA (US); Christopher Isamu Ryan, Lynnwood, WA (US)

(21) Appl. No.: 15/701,095

(22) Filed: Sep. 11, 2017

Related U.S. Application Data
(63) Continuation-in-part of application No. 15/162,137, filed on May 23, 2016.
Application No. 15/162,137 is a continuation of application No. 14/203,169, filed on Mar. 10, 2014, now Pat. No. 9,345,373.
Application No. 14/203,169 is a continuation-in-part of application No. 14/871,323, filed on Sep. 30, 2015.
(60) Provisional application No. 61/792,754, filed on Mar. 15, 2013.

(51) Int. Cl. A47L 11/34; A47L 11/40; F04D 23/00; F04D 17/16

(52) U.S. Cl. CPC A47L 11/34; F04D 23/008; F04D 17/168; F05B 2250/503; A47L 11/4083; A47L 11/4016; A47L 11/4097; A47L 11/4088; A47L 11/4005

(57) ABSTRACT

A cleaning system comprises a power plant, a regenerative blower having a power input shaft, a suction port, and a discharge port, an interface assembly configured for transmitting power from the power plant to the regenerative blower, a pump configured for generating pressurized water, and a heat exchanger system configured for heating the pressurized water.

### CLAIM OF PRIORITY

This application claims the benefit of priority to U.S. application Ser. No. 15/162,137, filed May 23, 2016, which claims priority to U.S. application Ser. No. 14/203,169, filed Mar. 10, 2014, which claims priority to U.S. Provisional Application Ser. No. 61/792,754, filed Mar. 15, 2013; and, U.S. Application Ser. No. 14/871,323, filed Sep. 30, 2015, which are incorporated herein by reference in their entirety.

### BACKGROUND

The present patent application relates to surface cleaning systems, and, more particularly, to a surface cleaning system that utilizes a regenerative blower as a vacuum source.

Cleaning carpet, upholstery, tile floors, and other surfaces enhances the appearance and extends the life of such surfaces by removing the soil embedded in the surface. Moreover, carpet cleaning removes allergens, such as mold, mildew, pollen, pet dander, dust mites, and bacteria. Indeed, regular cleaning keeps allergen levels low and thus contributes to an effective allergy avoidance program.

Vacuum extractors for cleaning surfaces, such as carpet, typically deposit a cleaning fluid upon the carpet or other surface to be cleaned. The deposited fluid, along with soil entrained in the fluid (e.g. “gray water”), is subsequently removed by high vacuum suction. This enables the carpet to be completely dry before mold has time to grow. The soiled fluid, i.e., waste fluid, is then separated from the working air and is collected in a recovery tank.

Due to the prevalence of carpeted surfaces in commercial establishments, institutions, and residences, there exists a thriving commercial carpet cleaning industry. In order to maximize the efficacy of the cleaning process, industrial floor cleaning systems should be powerful to minimize the time in which the soil entrained cleaning fluid is present in the carpet. Industrial floor cleaning systems should also be durable. That is, such a cleaning system should be manufactured from durable working parts so that the system has a long working life and requires little maintenance.

Industrial floor cleaning systems generally provide for the management of heat, vacuum, pressure, fresh and gray water, chemicals, and power to achieve the goal of efficient, thorough cleaning of different surfaces, usually carpets but also hard flooring, linoleum and other surfaces, in both residential and commercial establishments. Professional surface cleaning systems are also utilized in the restoration industry for water extraction,

Of the many industrial surface cleaning systems available, a major segment are self-contained having an own power plant, heat source, vacuum source, chemical delivery system, and water dispersion and extraction capabilities. These are commonly referred to as “slide-in” systems and install permanently in cargo vans, trailers, and other commercial vehicles, but can also be mounted on portable, wheeled carts. Slide-in systems comprise a series of components designed and integrated into a package with an overall goal of performance, economy, reliability, safety, useful life, serviceability, and sized to fit in various commercial vehicles.

Currently, the vacuum source found in the industrial surface cleaning systems comprises a positive displacement blower. One common type of positive displacement blower is a rotary blower. Rotary blowers typically include two or more meshing lobes that rotate within a blower chamber. In operation, as the lobes rotate, air is trapped in pockets surrounding the lobes and is carried from an intake side of the blower to an exhaust side of the blower. Positive displacement blowers are designed such that there is no contact between the lobes and the walls of the blower chamber, and the air is trapped due to the substantially low clearance between the components. However, because of the clearance that must be maintained between the lobes and the chamber walls, single-stage blowers can pump air across only a limited pressure differential. Furthermore, if the blower is used outside of its specified operating conditions, the compression of the air can generate such a large amount of heat that the lobes may expand to the point that they become jammed within the blower chamber, thereby damaging the pump. Because of the limited pressure differential that can be generated by a single-stage blower and the potential for damaging the blower if blower is run too hot, some industrial surface cleaning systems use blowers having multiple stages, which adds to the cost of the blower.

Positive displacement pumps, while popular, have several downfalls associated with their use. As discussed above, because rotary blowers are sensitive to heat, there is a risk of damaging the blower if the operation of the blower is not carefully monitored. Damage to the blower can include, for example, timing issues, clashing of the lobes, and total blower failure due to jamming of the components within the blower housing. Over time, reliability can also be an issue if proper maintenance is not performed. Rotary blowers also produce a significant amount of vibration during operation, which can lead to increased wear and tear on the blower and adjacent components of the cleaning system. Furthermore, rotary blowers can be very noisy. The noise produced by rotary blowers is not only a nuisance to those in the vicinity of the cleaning system, but it can also contribute to hearing loss if proper ear protection is not worn,

Further, of the many industrial surface cleaning systems available, a major segment are self-contained and have a heat source, vacuum source, chemical delivery system, and water dispersion and extraction capabilities. These are commonly referred to as “truck-mounted” systems and install permanently in cargo vans, trailers, and other commercial vehicles. Truck-mounted systems comprise a series of components designed and integrated into a package with an overall goal of performance, economy, reliability, safety, useful life, serviceability, and sized to fit in various commercial vehicles.

Current truck-mounted carpet cleaning machines use the internal combustion engine from the truck to drive the mechanical components (i.e., vacuum pumps, high pressure water pumps) of the system. Airflow and pressure within the system are typically controlled mechanically. Water temperature is typically controlled with valves, solenoids, and electric switches.

As a result, control of airflow, pressure and temperature with mechanical drive systems is limited by the design of the vehicle and the internal combustion engine used in the vehicle. This results in a limited number vehicles that can be used for the installation of the cleaning equipment. Mechanical drive systems must have a direct connection between the drive source (e.g. internal combustion engine) and the driven component (e.g. vacuum pump, water pump). This direct “line of sight” requirement results in modifications being required to the host vehicle, such as drilling and cutting holes in significant portions of the vehicle structure. Some vehicles cannot be utilized due to the physical design and layout of the vehicle power train. Since the drive system is fixed, the speed ratio between the engine and the driven components is also fixed by the system design.

In an attempt to simplify the installation of the cleaning system without having to make significant modifications to the vehicle, “slide-in” systems have been developed. Slide-in systems generally involve mounting of all the components of the vacuum system to a platform that can be placed, or slid, into the cargo area of a vehicle, such as a van. In other examples, these systems can alternatively be mounted on portable, wheeled carts. These systems have a dedicated power plant, such as an internal combustion engine, separate from the vehicle power plant. As such, these systems can be considerably more heavy and bulkier than truck-mounted systems. Furthermore, these systems also require ventilation systems to evacuate exhaust from the power plant from within the cargo area.

Performance of truck-mounted and slide-in cleaning systems relies on the operating conditions of the power plant to operate the cleaning system. For example, some cleaning surfaces require lower amounts of vacuum pressure and airflow so as not to damage the surface (i.e., upholstery). Common methods for controlling vacuum pressure are manually adjusted relief valves at the tool, hose, or on the machine, Methods for controlling air flow include changing the speed of the internal combustion engine. Changing the speed of the internal combustion engine changes where the engine operates in its efficiency curve. Lowering the speed generally means the engine is running less efficiently.

Also, different types of soil respond to different temperatures. Most cleaning equipment can only provide temperature control at the machine with little or no control over the applied temperature to the cleaning surface. Current truck-mounted carpet cleaning machines heat water by various heat transfer methods, either water-to-water or air-to-water. Available heat sources include the following: 1) the coolant system of the internal combustion engine, 2) vacuum pump exhaust, and 3) fuel fired heating equipment. Methods for controlling the temperature include mechanical thermostats, ball valves, water mixing valves, mechanical and electric float switches, mechanical and electric pressure switches, and mechanically operated air flow valves all designed to divert the path or flow of either the heating medium or the heated medium. These control systems typically have a large hysteresis, which can result in uneven application of heated cleaning solutions, affecting the appearance of cleaning results. Additionally, mechanical temperature control systems can provide imprecise control, which can result in temperature variation in the cleaning solution.

Furthermore, loss of heat through the solution hose can result in temperature variations at the cleaning surface. Changing the length of the hose can result in a change in temperature at the cleaning surface, without any measured change elsewhere in the system. These limitations can require the operator to estimate line loss and cleaning performance based on experience.

Overall system controls are generally limited to on/off switches, mechanical temperature controls, and mechanical and electric limit switches for pressure and volume. These controls require intervention by the operator to manually set limits and controls. Mechanical vacuum relief valves on the system result in waste of power (loss of system efficiency) as power is consumed to move air through the relief valve but provides no value to the cleaning process.

Example truck-mounted cleaning systems are described in U.S. Pat. No. 4,158,248 to Palmer and U.S. Pat. No. 6,675,437 to York. Example slide-in cleaning system are described in U.S. Pat. No. 7,208,050 to Boone et al. and U.S. Pat. No. 7,681,280 to Hayes et al.

### Overview

To better illustrate the cleaning system disclosed herein, a non-limiting list of examples is provided here:

In Example 1, a cleaning system can be provided that includes a power plant, a regenerative blower having a power input shaft, a suction port, and a discharge port, an interface assembly configured for transmitting power from the power plant to the regenerative blower, a pump configured for generating pressurized water, and a heat exchanger system configured for heating the pressurized water.

In Example 2, the cleaning system of Example 1 is optionally configured to include a support frame, wherein at least one of the power plant, the regenerative blower, and the pump is coupled to the support frame.

In Example 3, the cleaning system of any one of or any combination of Examples 1-2 is optionally configured to include one or more wands having an input configured to receive the pressurized water for distribution to a surface to be cleaned.

In Example 4, the cleaning system of Example 3 is optionally configured to include one or more delivery hoses extending between the pump and the one or more wands and configured to deliver the pressurized water to the one or more wands.

In Example 5, the cleaning system of Example 4 is optionally configured to include a vacuum recovery tank, the vacuum recovery tank having a first input coupled to the suction port of the regenerative blower and one or more second inputs coupled to one or more vacuum hoses extending between the recovery tank and the one or more wands.

In Example 6, the cleaning system of Example 5 is optionally configured to include a chemical distribution system configured to deliver a stream of cleaning chemical into the pressurized water for delivery by the one or more wands.

In Example 7, the cleaning system of Example 6 is optionally configured such that the discharge port of the regenerative blower is operably coupled to the heat exchanger system and configured to provide exhaust gases for heating the pressurized water.

In Example 8, the cleaning system of any one of or any combination of Examples 1-7 is optionally configured such that the regenerative blower includes an impeller coupled to the power input shaft.

In Example 9, the cleaning system of Example 8 is optionally configured such that the impeller is formed integral with the power input shaft.

In Example 10, the cleaning system of any one of or any combination of Examples 1-9 is optionally configured such that the power plant is a combustion engine.

In Example 11, the cleaning system of any one of or any combination of Examples 1-9 is optionally configured such that the power plant is an electric motor.

In Example 12, a cleaning system can be provided that includes a power plant having a power output shaft, a regenerative blower including a blower housing having a suction port and a discharge port and defining a blower chamber, the regenerative blower further including an impeller disposed within the blower chamber and a power input shaft extending from the impeller, an interface assembly configured for transmitting power from the power output shaft of the power plant to the power input shaft of the regenerative blower, a pump configured for generating pressurized water, a heat exchanger system configured for heating the pressurized water, and one or more wands having an input configured to receive the pressurized water for distribution to a surface to be cleaned.

In Example 13, the cleaning system of Example 12 is optionally configured to include a vacuum recovery tank, the vacuum recovery tank having a first input coupled to the suction port of the regenerative blower and one or more second inputs coupled to one or more vacuum hoses extending between the recovery tank and the one or more wands.

In Example 14, the cleaning system of any one of or any combination of Examples 12-13 is optionally configured such that the blower housing includes a first housing portion and a second housing portion configured to be secured together to substantially enclose the impeller.

In Example 15, the cleaning system of Example 14 is optionally configured to include a bearing assembly positioned between an inner surface of one of the first housing portion and the second housing portion and a central hub of the impeller, the bearing assembly configured to allow rotation of the impeller relative to the blower housing.

In Example 16, the cleaning system of any one of or any combination of Examples 12-15 is optionally configured such that the impeller includes a central hub and a plurality of blades extending around a circumference of the central hub, wherein each of the blades is curved between a first end adjacent to the central hub and a second end spaced from the central hub.

In Example 17, the cleaning system of any one of or any combination of Examples 12-16 is optionally configured such that the discharge port includes a silencer configured to reduce a noise output level of the regenerative blower.

In Example 18, the cleaning system of any one of or any combination of Examples 12-17 is optionally configured such that the power plant is a combustion engine.

In Example 19, the cleaning system of any one of or any combination of Examples 12-17 is optionally configured such that the power plant is an electric motor.

In Example 20, a vacuum extraction cleaning system can be provided that includes a power plant and a regenerative blower including a blower housing having a suction port and a discharge port and defining a blower chamber, one or more impellers disposed within the blower chamber, a power input shaft extending from the one or more impellers, and one or more bearings configured to allow rotation of the one or more impellers within the blower chamber. The vacuum extraction apparatus can further include an interface configured to allow coupling of the power plant to the power input shaft of the regenerative blower, a pump configured for generating pressurized water, a heat exchanger system configured for heating the pressurized water, one or more wands configured to receive the pressurized water for distribution to a surface to be cleaned, and a vacuum recovery tank, the vacuum recovery tank having a first input coupled to the suction port of the regenerative blower and one or more second inputs coupled to one or more vacuum hoses extending between the recovery tank and the one or more wands.

In Example 21, the cleaning system of any one of or any combination of Examples 1-20 is optionally configured such that all elements or options recited are available to use or select from.

In Example 22 a cleaning system can include: a power plant having a fluid cooling system; a generator mechanically coupled to the power plant; a motor electrically coupled to the generator; a pump coupled to the motor and configured for generating pressurized liquid; a blower coupled to the motor and configured for generating pressurized air; and a cleaning tool fluidly coupled to a pump outlet and a blower inlet; wherein the fluid cooling system is configured to heat liquid for the cleaning tool and cool the generator and motor.

In Example 23, the cleaning system of Example 22 is optionally configured to include first cooling lines connecting the fluid cooling system of the power plant and the generator to circulate coolant therebetween.

In Example 24, the cleaning system of any one of or any combination of Examples 22 and 24 is optionally configured to include second cooling lines connecting the fluid cooling system of the power plant and the motor in order circulate fluid therebetween; and a liquid-to-liquid heat exchanger in fluid communication with the second cooling lines and an inlet configured to receive liquid from the pump and an outlet for providing heated liquid to the cleaning tool.

In Example 25, the cleaning system of any one of or any combination of Examples 22-24 is optionally configured to include a preheater heat exchanger configured to heat liquid stored in a container using heated coolant from the fluid cooling system.

In Example 26, the cleaning system of any one of or any combination of Examples 22-25 is optionally configured to include a resistance heater positioned to heat liquid between the liquid-to-liquid heat exchanger and the cleaning tool.

In Example 27, the cleaning system of any one of or any combination of Examples 22-26 is optionally configured to include a resistance heater disposed in a hose connecting the cleaning tool to the liquid-to-liquid heat exchanger.

In Example 28, the cleaning system of any one of or any combination of Examples 22-27 is optionally configured to include a liquid-to-air heat exchanger positioned between the resistance heater and the liquid-to-liquid heat exchanger and configured to exchange heat between discharge air of the blower and the heated liquid.

In Example 29, the cleaning system of any one of or any combination of Examples 22-28 is optionally configured to include a temperature sensor positioned between the resistance heater and the cleaning tool; and a bypass valve connected to allow liquid to bypass the liquid-to-air heat exchanger when the temperature sensor senses a threshold temperature.

In Example 30, the cleaning system of any one of or any combination of Examples 22-29 is optionally configured to include a generator control connected to the generator to convert alternating current to direct current; and a motor control connected to the generator control and the motor to convert direct current to alternating current.

In Example 31, the cleaning system of any one of or any combination of Examples 22-30 is optionally configured to include a pressure control connected to the motor control and configured to adjust a voltage signal sent to the motor by the motor controller to limit a maximum air pressure at the wand; and a flow control connected to the motor control and configured to adjust a voltage signal sent to the motor by the motor control to limit a minimum airflow through the wand.

In Example 32, the cleaning system of any one of or any combination of Examples 22-31 is optionally configured to include a vacuum sensor connected to the motor control and configured to sense a pressure of a vacuum tank connected to the blower.

In Example 33, a method of operating a cleaning system can include: driving an electric generator with a power plant of a vehicle; powering an electric motor with power from the electric generator; cooling the electric generator and the electric motor with cooling fluid of the power plant; heating a cleaning fluid with heat from the cooling fluid; and driving a fluid pump with the electric motor to pump cleaning fluid to a cleaning tool.

In Example 34, the method of Example 33 is optionally configured to include heating the cleaning fluid with heat from the cooling fluid at the fluid pump inlet and the fluid pump outlet using liquid-to-liquid heat exchangers.

In Example 35, the method of any one of or any combination of Examples 33 and 34 is optionally configured to include heating the cleaning fluid between the cooling fluid and the cleaning tool with an electric heater.

In Example 36, the method of any one of or any combination of Examples 33-35 is optionally configured to include driving a blower with the electric motor to draw cleaning fluid away from a discharge of the cleaning tool.

In Example 37, the method of any one of or any combination of Examples 33-36 is optionally configured to include heating the cleaning fluid in route to the cleaning tool with discharge air from the blower using a liquid-to-air heat exchanger.

In Example 38, the method of any one of or any combination of Examples 33-37 is optionally configured to include sensing a temperature of the cleaning fluid at the cleaning tool; and bypassing the liquid-to-air heat exchanger when a sensed temperature exceeds a threshold temperature.

In Example 39, the method of any one of or any combination of Examples 33-38 is optionally configured to include controlling output of the electric generator with a generator control that converts alternating current to direct current; and controlling input to the electric motor with a motor control that converts direct current to alternating current.

In Example 40, the method of any one of or any combination of Examples 33-35 is optionally configured to include adjusting a voltage signal sent to the electric motor by the motor control to limit a maximum air pressure at the cleaning tool; and adjusting a voltage signal sent to the electric motor by the motor control to limit a minimum airflow through the cleaning tool.

In Example 41, the method of any one of or any combination of Examples 33-40 is optionally configured to include sensing pressure in a vacuum tank connected to the blower.

In Example 42, an electrical generator system for a vehicle can include: a power plant having a fluid cooling system; an alternating current generator mechanically coupled to the power plant; a generator control coupled to receive electrical input from the alternating current generator; and an engine speed control configured to receive a control signal from the generator control and to provide an input to the power plant to control speed of the power plant; wherein the fluid cooling system is configured to cool the alternating current generator.

In Example 43, the electrical generator system of Example 42 is optionally configured to include a power plant comprising an internal combustion engine that generates rotational shaft power; and a fluid cooling system including a heat exchanger configured to exchange heat from coolant heated by the power plant to the atmosphere.

In Example 44, the electrical generator system of any one of or any combination of Examples 42 and 43 are optionally configured to include a plurality of electrical contactors configured to interrupt reception of electrical input from the alternating current generator by the generator control; and a battery connected to the generator control.

In Example 45, the electrical generator system of any one of or any combination of Examples 42-44 is optionally configured to include an inverter connected to the generator control to generate direct current power.

In Example 46, the electrical generator system of any one of or any combination of Examples 42-45 is optionally configured to include a motor electrically powered by the alternating current generator.

In Example 47, the electrical generator system of any one of or any combination of Examples 42-46 is optionally configured to include a liquid pump mechanically powered by the motor; and an air blower mechanically powered by the motor.

In Example 48, the electrical generator system of any one of or any combination of Examples 42-47 is optionally configured to include a fluid cooling system used to cool the generator and the motor, and heat liquid pumped by the liquid pump.

In Example 49, the electrical generator system of any one of or any combination of Examples 42-48 is optionally configured to include heated liquid used in conjunction with a carpet cleaning tool that utilizes a vacuum generated by the air blower.

In Example 50, the devices, systems, or methods of any one of or any combination of Examples 1-49 is optionally configured such that all elements or options recited are available to use or select from.

Each of these non-limiting examples can stand on its own, or can be combined in any permutation or combination with any one or more of the other examples. This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document,

FIG. 1 is a diagrammatic illustration of an industrial slide-in cleaning system, in accordance with at least one example of the present disclosure.

FIG. 2 is a further diagrammatic illustration of the cleaning system of FIG. 1, in accordance with at least one example of the present disclosure.

FIG. 3 is an exploded perspective view of a drive system, in accordance with at least one example of the present disclosure.

FIGS. 4A-E are perspective, front, rear, side, and top views, respectively, of a regenerative blower, in accordance with at least one example of the present disclosure.

FIGS. 5A and 5B are exploded perspective and side views, respectively, of the regenerative blower of FIGS. 4A-E, in accordance with at least one example of the present disclosure.

FIG. 6 is a perspective view of an impeller for a regenerative blower, in accordance with at least one example of the present disclosure.

FIG. 7 is a perspective view of a regenerative blower configured to be powered by an electric drive assembly, in accordance with at least one example of the present disclosure.

FIG. 8 is a diagrammatic illustration of an industrial slide-in cleaning system installed in a truck.

FIG. 9 is a schematic illustration of an electric carpet cleaning system showing fluid and mechanical connections, in accordance with at least one example of the present disclosure.

FIG. 10 is a schematic illustration of an electrical system for the electric carpet cleaning system of FIG. 9, in accordance with at least one example of the present disclosure.

FIG. 11 is a schematic illustration of a temperature control circuit for the electric cleaning system of FIG. 9, in accordance with at least one example of the present disclosure.

FIG. 12 is a schematic illustration of the electrical system of FIG. 3 configured to have an A/C voltage output, in accordance with at least one example of the present disclosure.

### DETAILED :DESCRIPTION

The present patent application relates to a regenerative blower for a cleaning system, such as a truck-mounted cleaning system, that utilizes vacuum extraction to remove gray water from a floor surface. Truck-mounted cleaning systems generally fall into two categories, including slide-in systems and vehicle-powered systems. Slide-in systems can be powered by their own engines, or power plants, and can be supported by a frame that is secured to the vehicle. Vehicle-powered systems differ from slide-in systems in that they receive power from the engine, or power plant, of the vehicle rather than from a dedicated engine of the cleaning system. However, both slide-in systems and vehicle-powered systems can include components for supplying cleaning solution, heat, pressure, and vacuum for the cleaning operation.

One benefit of slide-in systems over vehicle-powered systems is that they can be transferred between vehicles with relative ease. However, as compared to vehicle-powered systems, slide-in systems generally require more cargo space in a vehicle.

For purposes of example only, the cleaning system of the present disclosure is described as a slide-in cleaning system. However, various components of the cleaning system, such as the drive system, can be modified to provide for a vehicle-powered system rather than a slide-in system. Thus, both slide-in systems and vehicle-powered systems are within the intended scope of the present disclosure.

The present application is also directed to a vehicle-mounted cleaning system that can utilize the power plant of the vehicle to mechanically drive an electric generator. The electric generator can subsequently provide electrical power to an electric motor that can be used to mechanically drive a vacuum pump and a. liquid pump. As such, the power plant of the vehicle can be left to operate at an efficient level while the cleaning system is used, but the electric generator is capable of operating within the entire operating range of the power plant.

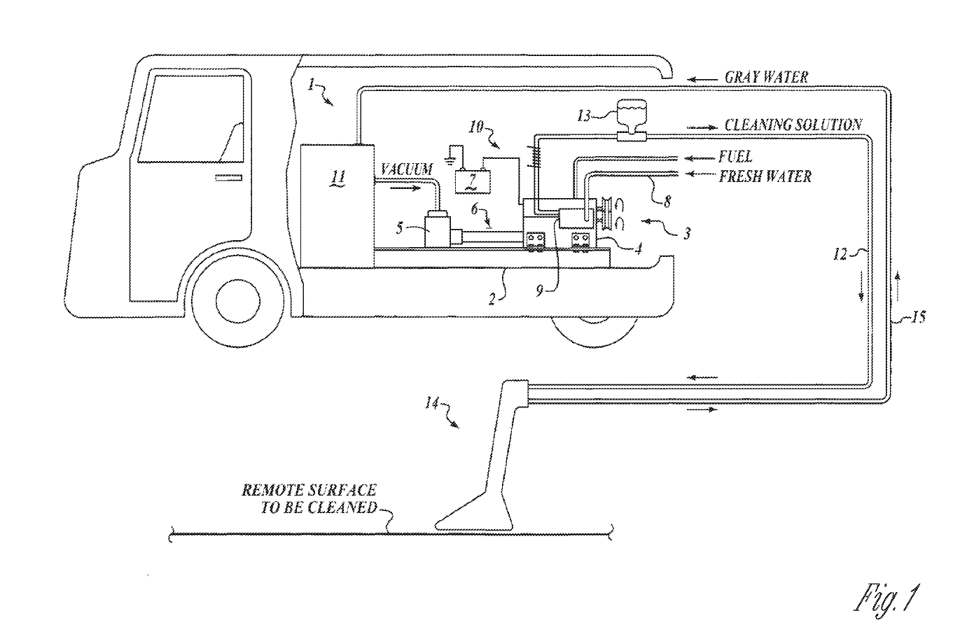

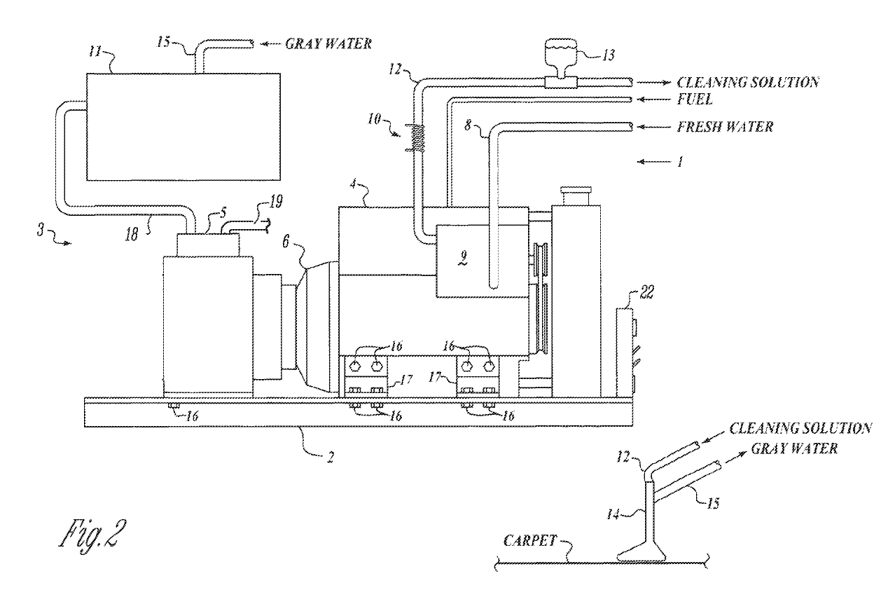

FIG. 1 is a diagrammatic illustration of a slide-in cleaning system 1 configured cleaning carpets, hard flooring, linoleum, and other surfaces in accordance with at least one example of the present disclosure. As illustrated in FIG. 1, the cleaning system 1 can include a structural platform or support frame 2 onto which various components can be mounted. In an example, the cleaning system 1 can include a drive system 3 mounted on the support frame 2 and having a power plant 4 coupled to receive fuel from an appropriate supply, a regenerative blower 5 that can operate as the vacuum source for removing soiled liquid from the cleaned surface, and an interface assembly 6 for transmitting power from the power plant 4 to the regenerative blower 5. The power plant 4 can be, for example, any steam or internal combustion motor, such as a gasoline, diesel, alcohol, propane, or other fueled internal combustion engine. Alternatively, the power plant 4 can be an electric motor driven by a battery or other source of electric power, or a hybrid motor that operates on both electric power and a fuel power source. As discussed above, in a vehicle-driven system, the power plant can be the engine of the vehicle in which the cleaning system is mounted. With further reference to FIG. 1, a battery 7 can be provided as a source of electric energy for starting the power plant 4. An intake hose 8 can be coupled to a source of fresh water, and a water pump 9 can be driven by the power plant 4 via any suitable means, such as a V-belt or a direct drive, for pressurizing the fresh water.

As illustrated in FIG. 1, one or more heat exchanger systems 10 can be coupled for receiving and heating the pressurized fresh water. A recovery tank 11 can be provided for storing gray water after removal from the cleaned surface. A high pressure solution hose 12 can be provided for delivering pressurized, hot water or a hot water and chemical solution from the cleaning system 1 to a surface to be cleaned. In an example, a chemical container 13 or other chemical system can be coupled for delivering a stream of cleaning chemical into the hot water as it enters the high-pressure solution hose 12. At least one wand 14 can be coupled to the high pressure solution hose 12 for receiving and dispersing the pressurized hot water or hot water and chemical cleaning solution to the surface to be cleaned. In various examples, two or more wands 14 can be provided, wherein each wand 14 is coupled to a dedicated high pressure solution hose 12. The wand 14 can be removed from the vehicle and carried to the carpet or other surface to be cleaned. Thus, in an example, the wand 14 can be the only “portable” part of cleaning system 1, with all other components of the cleaning system 1 remaining stationary within the vehicle during a cleaning operation. The delivery wand 14 can be coupled via a vacuum hose 15 to the recovery tank 11, which can in turn be coupled to the high vacuum provided by the regenerative blower 5, for recovering the used cleaning solution from the cleaned surface and delivering it to the recovery tank 11.

In an example, the power plant 4 and the regenerative blower 5 of the drive system 3 can be independently hard-mounted on the support frame 2 either directly using one or more mechanical fasteners 16, or indirectly using one or more mounting plates or brackets 17. In an alternative example, the power plant 4 and the regenerative blower 5 can be mounted together as a combined unit, which is then mounted either directly or indirectly on the support frame 2. Thus, independent mounting of the power plant 4 and the regenerative blower 5 is shown merely for purposes of example and not limitation. Any suitable mechanical fasteners 16 can be used including, but not limited to, bolts, screws, or the like. The brackets 17 can be formed from any suitable material, such as metal. The support frame 2 can be configured for mounting in a van, truck or other suitable vehicle for portability, as illustrated in FIG. 1. In an example, the support frame 2 can be wheeled for portability independent of the vehicle, and can optionally be sized and structured to incorporate the recovery tank 11.

The cleaning system 1 can operate by delivering fresh water to an inlet of the system utilizing, for example, a standard garden hose or a fresh-water container. The system can add energy to the fresh water, i.e., pressurize it, by means of the pump 9. The fresh water can be pushed throughout the one or more heat exchanger systems 10 using pressure provided by the pump 9. The one or more heat exchanger systems 10 can gain their heat by thermal energy rejected from the regenerative blower 5 or the power plant 4, e.g., from hot exhaust gasses, coolant water used on certain engines, or other suitable means. On demand from the wand 14, the pump 9 can drive the heated water through the solution hose 12 where one or more cleaning chemicals can be added from the chemical container 13, and then can deliver the water-based chemical cleaning solution to the wand 14 for cleaning the floor, carpet or other surface. The hot water can travel, for example, between about 50 feet and about 300 feet to the wand 14. The operator can deliver the hot solution via the wand 4 to the surface to be cleaned, and can almost immediately extract the solution along with soil that has been emulsified by thermal energy or dissolved and divided by chemical energy. The extracted, soiled water can be drawn via the vacuum hose 15 into the recovery tank 11 for eventual disposal as gray water. An auxiliary pump (not shown), commonly referred to as an APO or Automatic Pump Out device, may be driven by the power plant 4 for automatically pumping the gray water from the recovery tank 11 into a sanitary sewer or other approved dumping location, Alternatively, this task can be performed manually.

Various types of interface assemblies 6 can be used for transmitting power from the power plant 4 to the regenerative blower 5. A non-exhaustive subset of such interface assemblies is discussed below, However, it should be understood that regenerative blowers in accordance with the present disclosure can be utilized in cleaning systems that incorporate any type of interface assembly. Thus, the interface assemblies described herein are provided merely for purposes of example and not limitation. Furthermore, the type of interface assembly utilized can depend on the type of power plant selected for a particular cleaning system, such as an internal combustion engine or an electric motor.

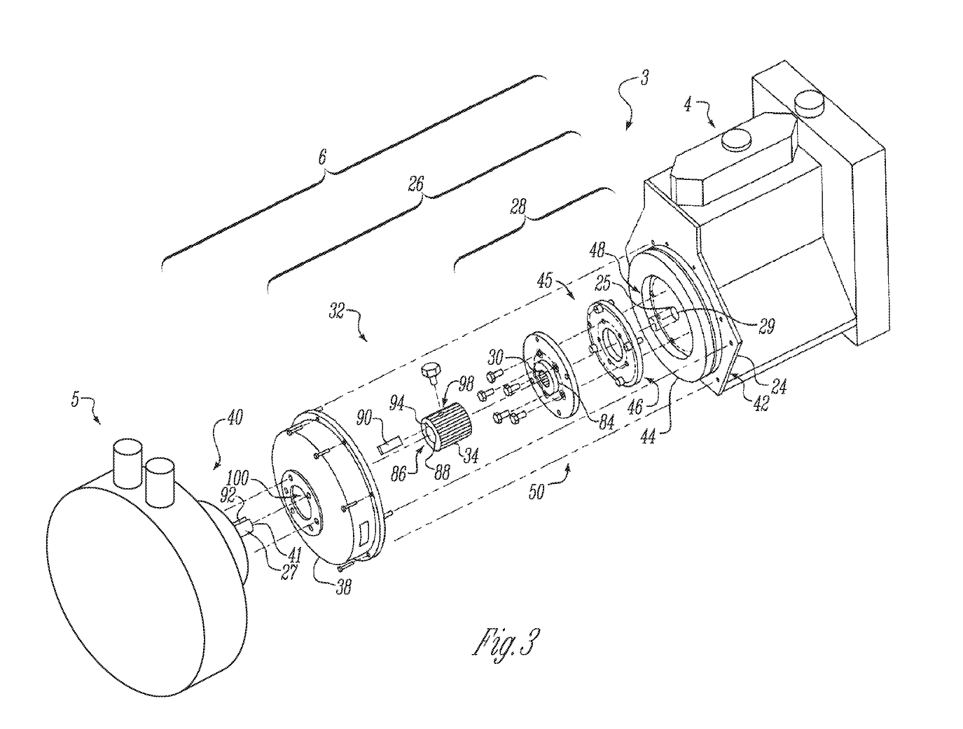

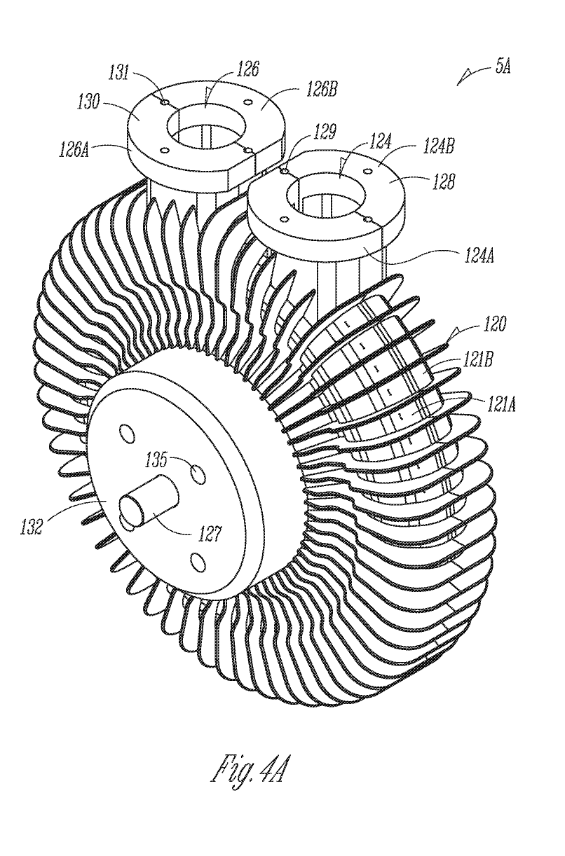

One type of interface assembly that can be used for transmitting power from the power plant 4 to the regenerative blower 5 is a rigid, direct drive coupling, which is discussed in further detail below with reference to FIGS. 2 and 3. Another type of interface assembly can include a belt drive system, which can be configured to transmit power through a series of pulleys and belts coupled to the power plant 4 and regenerative blower 5. Another type of interface assembly can include a flexible coupling, such as a “Waldron” coupling, Waldron couplings can generally utilize two hubs that can be structured for positive mounting on respective power plant and blower shafts. External splines on the hubs can be engaged by internal splines cut on a bore of a casing or sleeve surrounding the hubs. The external and/or internal splines can be formed of an elastomer, such as neoprene or nylon, for absorbing vibrations and impacts due to fluctuations in shaft torque or angular speed. Alternative flexible couplings for transmitting power from the power plant 4 to the regenerative blower 5 can include chain couplings that use either silent chains or standard roller chains with mating sprockets, and steelflex couplings that use two grooved steel hubs keyed to the respective shafts, wherein connection between the two hubs can be accomplished with a specially tempered alloy-steel member called a “grid.” Another type of interface assembly can include a universal joint, such as a Bendix-Weiss “rolling-ball” universal joint. Rolling ball universal joints can provide constant angular velocity with torque being transmitted between two yokes through a set of balls such that the centers of all of the balls lie in a plane which bisects the angle between the shafts of the power plant 4 and the regenerative blower 5. Another type of interface assembly can include a fluid coupling, wherein power is transmitted by kinetic energy in the operating fluid rather than through a mechanical connection between the shafts of the power plant 4 and the regenerative blower 5. Yet another type of interface assembly can include a clutch, which can permit disengagement of the coupled shafts of the power plant 4 and the regenerative blower 5 during rotation. Positive clutches, such as jaw and spiral clutches, can be configured to transmit torque without slip. Friction clutches can be configured to reduce coupling shock by slipping during engagement, and can also serve as safety devices by slipping when the torque exceeds their maximum rating.

FIG. 2 is a further diagrammatic illustration of the cleaning system 1 of FIG. 1. The cleaning system 1 is illustrated with a rigid, direct drive interface assembly 6 merely for purposes of example and illustration. Thus, any suitable interface assembly, including but not limited to those describe above, can be used to transmit power between the power plant 4 and the regenerative blower 5. As discussed above with reference to FIG. 1, the drive system 3 can include the power plant 4, the regenerative blower 5, and the interface assembly 6. As further illustrated in FIG. 2, the regenerative blower 5 can be coupled via vacuum piping 18 for generating high vacuum in the recovery tank 11, which can provide a suitable volume for carpet and other surface cleaning operations and can include baffles, filters, and/or other means for preventing gray or other water from entering the regenerative blower 5. Additionally, regenerative blowers themselves can be designed such that they are substantially impervious to water and debris ingestion. The recovery tank 11 can be mounted, for example, in the vehicle near the drive system 3, as illustrated in FIG. 1. An output of the regenerative blower 5 can be operably coupled, via exhaust piping 19, to the heat exchanger system 10 for delivering exhaust gases to heat the pressurized water.

In an example, as illustrated in FIG. 2, the power plant 4, the regenerative blower 5, and the interface assembly 6 of the drive system 3 can be joined together as an integral structural unit and mounted on the support frame 2. Particularly, in an example, the components of the drive system 3 can be co-mounted on the support frame 2 in metal-to-metal contact therewith. As illustrated in FIG. 2, the components can be mounted to the support frame 2 using one or more mechanical fasteners 16 and, optionally, one or more mounting plates or brackets 17. The support frame 2 can be, as discussed above, used for mounting the cleaning system 1 in a van, truck, or other suitable vehicle for portability. Thus, the support frame 2 can provide a mounting surface for attaching the cleaning system 1 to the vehicle, shown in FIG. 1, and can also provide for vibration damping during operation of the cleaning system 1. As further illustrated in FIG. 2, the support frame 2 can include an operations panel 2.2 for mounting gages, switches, and controls useful in operation of the cleaning system 1, whereby an operator can read the gages, operate the switches, and operate thermal and fluid management systems.

FIG. 3 is an exploded perspective view of the drive system 3 in accordance with at least one example of the present disclosure. As illustrated in FIG. 3, the interface assembly 6 can include an adapter plate 24 secured to the power plant 4 adjacent to a power output shaft 25 of the power plant 4 and a coupler assembly or coupling means 26 for coupling a power input shaft 27 of the regenerative blower 5 in rigid, rotationally fixed contact to the power output shaft 25 of the power plant 4. The coupling means 26 can include a flywheel assembly 28 having a power input surface 29 rotationally secured in rigid contact to the power output shaft 25 of the power plant 4 external to the adapter plate 24, a power output surface 30, and a rigid coupling 32 having a power input surface 34 rotationally secured between the output surface 30 of the flywheel assembly 28 and the power input shaft 27 of the regenerative blower 5 for transmitting rotational power thereto in the form of torque from the flywheel assembly 28. The interface assembly 6 can further include a rigid structural connector 38 secured between the adapter plate 24 of the power plant 4 and a face 40 of the regenerative blower 5 adjacent to the power input shaft 27, the connector 38 being structured to rigidly coaxially align the power input shaft 27 of the regenerative blower 5 and the power output shaft 25 of the power plant 4. The connector 38 can be sized to space a distal or end face 41 of the power input shaft 27 in close proximity to the output surface 30 of the flywheel assembly 28.

As illustrated in FIG. 3, the flywheel assembly 28 can include, for example, the adapter plate 24 that is bolted or otherwise secured to a face 42 of the power plant 4 whereat the power output shaft 25 outputs as torque power generated by the power plant 4. A flywheel 44 can be mounted on the power output shaft 25 for transmitting power output by the power output shaft 25. The flywheel assembly 28 can also include a rigid annular disk or plate 45 having a power input surface 46 configured to be secured to a power output face 48 of the flywheel 44. The annular plate 45 can be structured of suitable material, diameter and thickness to transmit torque generated by the power plant 4. The flywheel assembly 28, as illustrated in FIG. 3. can also include a coupling hub 50 that can be secured to the annular plate 45. The coupling hub 50 can include the output surface 30 and can be structured of suitable material, diameter and thickness for transmitting torque generated by the power plant 4 and transmitted through the flywheel 44 and annular plate 45.

The coupling hub 50 can include a central hub portion 84 that can be structured with the flywheel assembly output surface 30 for forming a substantially inflexible or rigid, rotationally fixed mechanical joint with the power input shaft 27 of the regenerative blower 5 for directly transmitting torque thereto from the power plant 4. For example, the flywheel assembly output surface 30 can be a bore in the central hub portion 84, the bore being formed with an internal spline, a keyway, or other suitable means for forming a rigid and rotationally fixed joint with the power input surface 34 of the coupling 32, and thereafter to the regenerative blower input shaft 27.

The coupling 32 can include, for example, a hub 86 formed with the power input surface 34 and a power output surface 88. The power input surface 34 can be structured to cooperate with the power output surface 30 portion of the coupling hub 50 to form a rigid, rotationally fixed joint. For example, when the power output surface 30 is a bore that includes an internal spline, the power input surface 34 of the cooperating hub 86 can include an external spline structured to mate with the internal spline 30.

The power output surface 88 can be structured to cooperate with the power input drive shaft 27 to form a rigid, rotationally fixed joint therewith. The hub 86 can thereby form a rigid, rotationally fixed joint between the regenerative blower 5 and the power plant 4 for directly transmitting torque thereto. For example, the power output surface 88 can include an internal bore sized to accept the power input shaft 27 of the regenerative blower 5.

The coupling 32 can also include means for rotationally fixing the hub 86 relative to the regenerative blower power input shaft 27. For example, a key 90 can be inserted in respective cooperating keyways 92, 94 in the input drive shaft 27 of the regenerative blower 5 and the internal bore 88 of the hub 86. The key 90 can therefore rotationally fix the hub 86 relative to the blower shaft 27 for transmitting torque through the interface assembly 6 to the regenerative blower 5.

In an example, the structural connector 38 can be configured as a rigid metal housing that can be bolted or otherwise secured to the face 40 of the regenerative blower 5 adjacent to where the power input shaft 27 projects. An opposing side of the structural connector can be bolted or otherwise secured to the adapter plate 2.4 of the power plant The structural connector 38 can be configured to precisely and coaxially align the power input shaft 27 of the regenerative blower with the power output shaft 25 of the power plant 4.

After being rigidly joined and rotationally secured to the power input shaft 27 of the regenerative blower 5 as described herein, the splined hub 86 can be inserted into the internally splined central hub portion 84 of the coupling hub 50. The intermeshed output and input splines 30, 34 can thereby conjoin the power input shaft 27 in rigid, rotationally fixed contact with the power output shaft 25. Torque generated by the power plant 4 can thus be transmitted to the regenerative blower 5 without relative rotational motion between the power output and input shafts 25, 27.

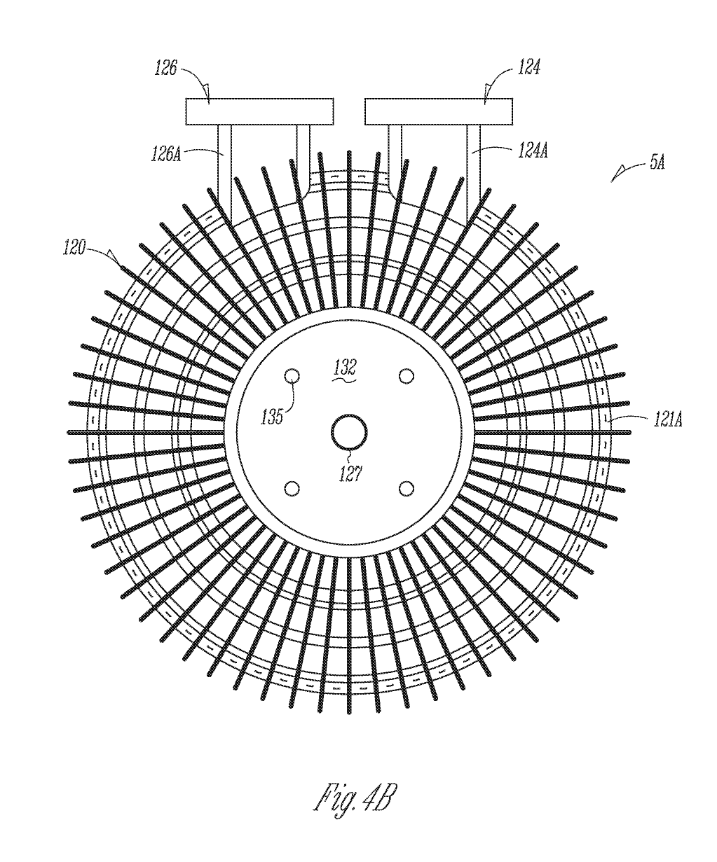

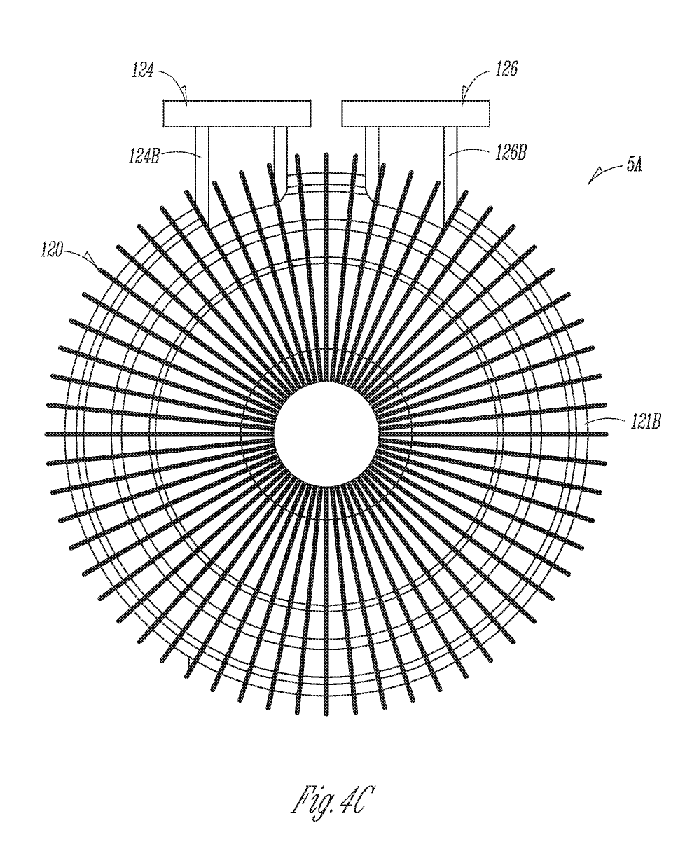

FIGS. 4A-E are perspective, front, rear, side, and top views, respectively, of a regenerative blower 5A, which represents one example of the regenerative blower 5 in accordance with the present disclosure. :In general, regenerative blowers can be configured for moving large volumes of air at low pressure, thereby creating a vacuum source. Unlike positive displacement pumps, regenerative blowers can be configured for regenerating air molecules through a non-positive displacement process to create to the vacuum source. Particularly, regenerative blowers are dynamic compression devices that utilize a non-contacting impeller to accelerate the air molecules within a blower housing to compress the air. In various examples, cooling can be accomplished by blowing air over the blower housing or using cooling fins formed on the blower housing. Suction and discharge ports of the regenerative blower can include a silencer for reducing the noise output of the blower and a filter, such as a mesh screen, for preventing the passage of debris.

As illustrated in FIGS. 4A-E the regenerative blower 5A can include a blower housing 120 having a first housing portion 121A and a second housing portion 1213, a suction port 124 configured to be coupled to the vacuum piping 18 (FIG. 2) for generating high vacuum in the recovery tank 11, and a discharge port 126 configured for exhausting air from within an interior of the blower housing 120. An upper flange portion 128 of the suction port 124 can include one or more mounting features, such as mounting apertures 129, configured to allow coupling of the suction port 124 to the recovery tank 11 or associated piping. An upper flange portion 130 of the discharge port 126 can include one or more mounting features, such as mounting apertures 131, configured to allow coupling of the discharge port 126 to exhaust piping. The suction port 124 can include a first suction port portion 124A extending from the first housing portion 121A and a second suction port portion 124B extending from the second housing portion 121B. Similarly, the discharge port 126 can include a first discharge port portion 126A extending from the first housing portion 121A and a second discharge port portion 126B extending from the second housing portion 121B. In an example, the discharge port 126 can be fluidly coupled to another component of the cleaning system 1, such as the heat exchanger system 10, for providing heated air thereto, The heated air from the discharge port 126 can, in various examples, be utilized at least in part for heating the pressurized fresh water that will be mixed with cleaning solution and delivered to the wand 14.

In an example, the blower housing 120 can be coupled to a bracket or mounting plate (not shown) that is configured to be secured to the support frame 2 (FIGS. 1 and 2). The blower housing 12.0 can be formed from any suitable material, such as a metallic material. In an example, the blower housing 120 can be formed from die-cast aluminum. Optionally, the blower housing 120 can be coated or plated with a suitable material, such as a nickel coating. The coating or plating can prevent, among other things, oxidization or corrosion of the blower housing 120 when contacted by water and chemical solutions.

As further illustrated in FIGS. 4A-E, a power input shaft 127 of the regenerative blower 5A can extend through an opening in a front face 132 of the blower housing 120. The power input shaft 127 can be driven by a suitable power plant, such as the power plant 4 of the slide-in cleaning system 1 illustrated in FIGS. 1 and 2. In an example, the front face 132 of the regenerative blower 5A can include one or more mounting features, such as mounting apertures 135, configured to allow coupling of the regenerative blower 5A to an interface assembly, such as the interface assembly 6. However, as discussed above, the regenerative blower 5A can be driven by alternative power plants, such as via a drive shaft (or power output shaft) extending from a vehicle engine in a vehicle-powered system, or from an electric motor. As further discussed above, any suitable interface assembly, including but not limited to those referenced herein, can be used to transmit rotation and torque from the power plant to the power input shaft 127.

In operation, air can be drawn from the recovery tank 11 (FIG. 2) into the regenerative blower 5A through the suction port 124. The air molecules in the air flow drawn into the regenerative blower 5A can be repeatedly struck by an impeller thereby accelerating and compressing the air molecules. In an example, the air molecules substantially complete one revolution within the blower housing 120 before they are exhausted through the discharge port 126. Because the recovery tank 11 is substantially sealed from the atmosphere, suctioning air from the recovery tank 11 through the regenerative blower 5A causes a low pressure to be generated within the tank. This low pressure can allow for vacuum extraction of gray water through the vacuum hose extending between the wand 14 and the recovery tank 11.

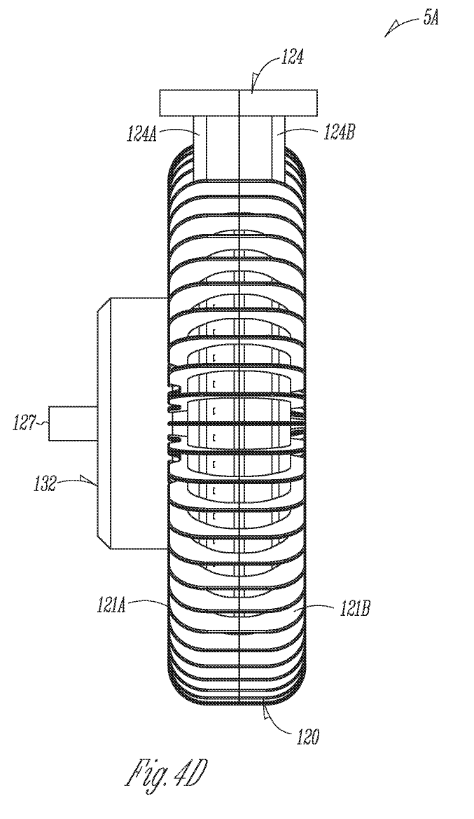

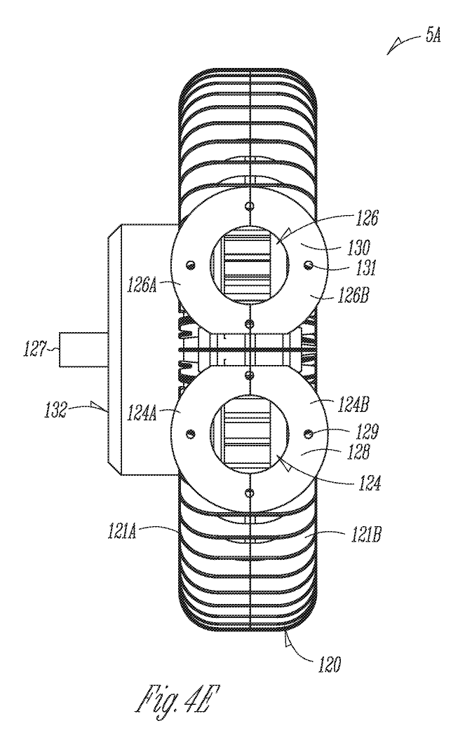

FIGS. 5A and 5B are exploded perspective and side views, respectively, of the regenerative blower 5A in accordance with at least one example of the present disclosure. As illustrated in FIGS. 5A and 5B, the regenerative blower 5A can include an impeller 133 configured to be positioned within an interior chamber 134 of the blower housing 120. In an example, as shown in FIGS. 5A and 5B, the impeller 133 can be formed integral with the power input shaft 127, or the power input shaft 127 can be permanently fixed to the impeller by a suitable connection means such as welding. In other examples, the power input shaft 127 can be a separate component from the impeller 133, and the two components can be coupled together during assembly, such as by a keyway fitting.

As further illustrated in FIGS. 5A and 5B, a first bearing 136 can be positioned between a first side 138 of the impeller 133 and the first housing portion 12 IA. In an example, the first bearing 136 can be configured to receive a first end 139 of the power input shaft 127. The first bearing 136 can be secured to an inner surface of the first housing portion 121A using any suitable connection means, such as by a press-fit connection or one or more fastening members configured to engage the first bearing 136 and the first housing portion 121A. Similarly, a second bearing 140 can be positioned between a second side 142 of the impeller 133 and the second housing portion 121B. In an example, the second bearing 140 can be configured to receive a second end 144 of the power input shaft 127. The second bearing 140 can be secured to an inner surface of the second housing portion 121B using any suitable connection means, such as by a press-fit connection into a channel 146 formed in the inner surface of the second housing portion 121B, or one or more fastening members configured to engage the second bearing 140 and the second housing portion 121B.

The first housing portion 121A can be coupled to the second housing portion 121B using any suitable connection means. In an example, as illustrated in FIG. 5A, the first housing portion 121A can include one or more flanges 154A each including an aperture 156A. Similarly, the second housing portion 121B can include one or more flanges 154B each including an aperture 156B. In order to couple the first housing portion 121A to the second housing portion 121B, the one or more flanges 154A of the first housing portion 121A can be aligned with the one or more flanges 154B of the second housing portion 121B. Subsequently, a fastening member 160 can be inserted through the apertures 156A, 156B of the aligned flanges 154A and 154B. In an example, the fastening member 160 can be threaded, such as a bolt or a screw, and can be configured to mate with a mounting nut 162 on an opposing side of the flange 154B. A washer 164 can also be positioned between the flange 154A and the fastening member 160.

As further illustrated in FIGS. 5A and 5B, the first housing portion 121A can include a series of fins 166A extending from an outer surface. Similarly, the second housing portion 121B can include a series of fins 166B extending from an outer surface. In an example, the fins 166A and 166B can assist with the dissipation of heat from within the blower housing 120 during operation of the regenerative blower 5A.

In an example, as illustrated in FIG. 5A, the discharge port 126 can be configured to receive a muffler or silencer member 168 therein. The silencer member 168 can be configured to, for example, muffle the output noise level generated from the exhaust directed through the discharge port 126. In an example, the silence member 168 can be configured to reduce the noise output level to about 70 decibels or less.

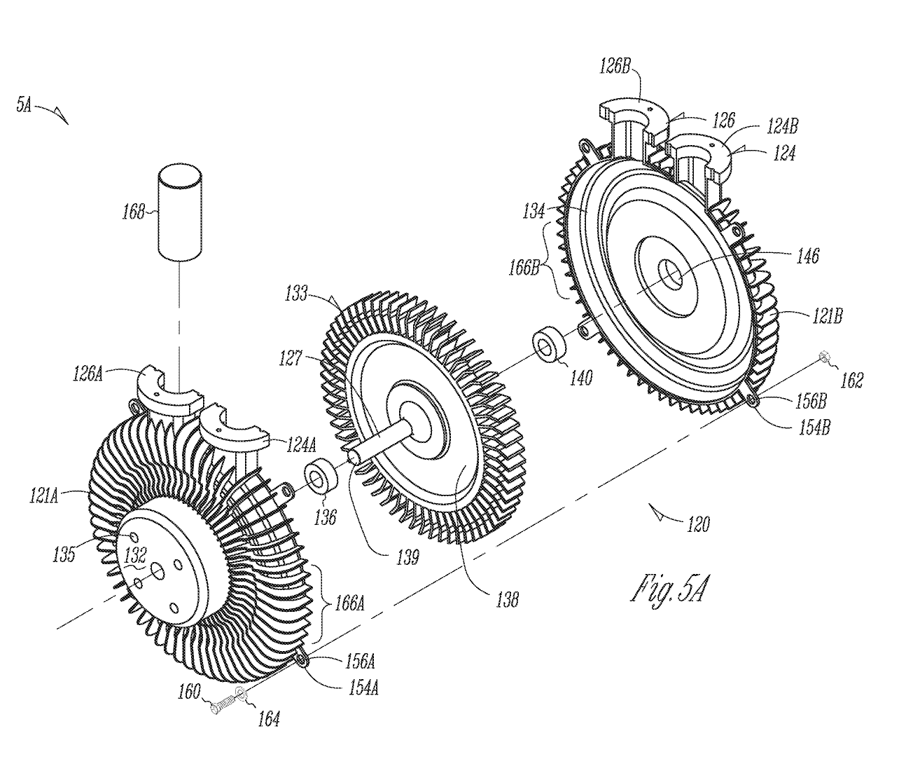

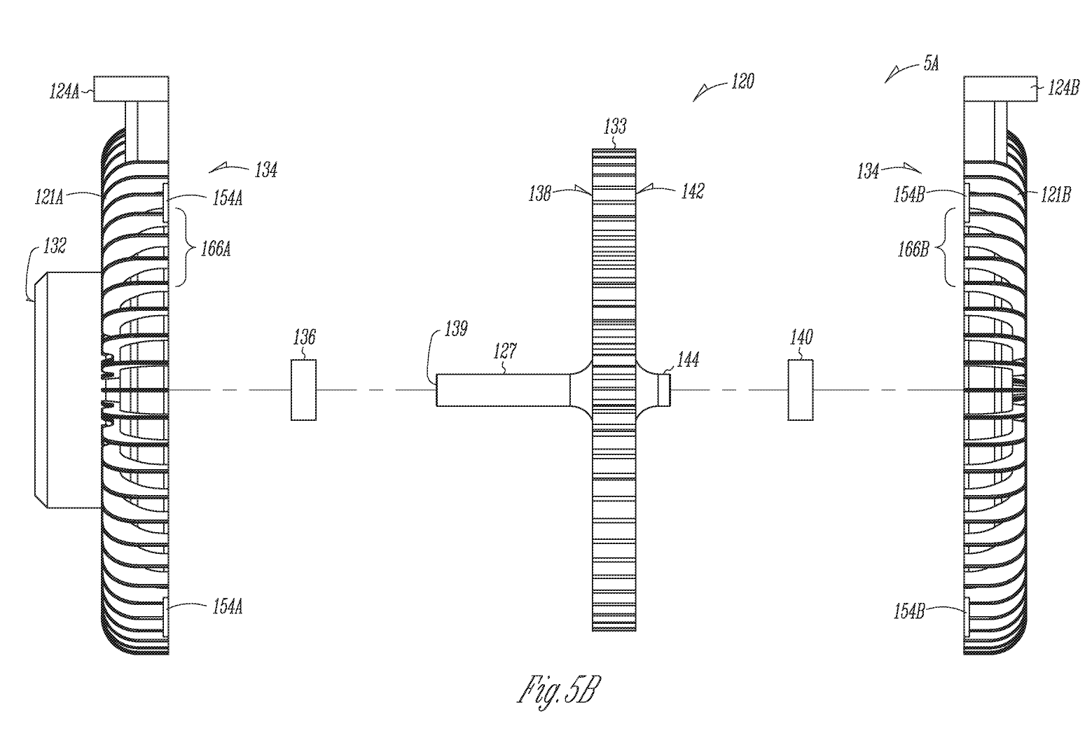

FIG. 6 is a perspective view of the impeller 133 in accordance with at least one example of the present disclosure. As illustrated in FIG. 6, the impeller 133 can include a central hub 170 and a plurality of blades 172 extending around a circumference of the central hub 170. In an example, at least a portion of each of the blades 172 can be bent or curved between a first end 174 adjacent to the central hub 170 and an opposite second end 176 spaced from the central hub 170. In an example, the curvature of the blades 172 can assist with circulation of the air molecules within the blower housing 120. The blades 172 are illustrated as having an identical curvature merely for purposes of example and not limitation. In other examples, one or more of the blades 172 can have a curvature that is different from the other blades 172.

As discussed above, in an example, the impeller 133 can be formed integral with the power input shaft 127, such as by a casting process. However, the power input shaft 127 can be formed separate fr©m the impeller 133, and the two components can be coupled together using any suitable coupling means. Furthermore, the blades 172 can be formed separate from the central hub 170 and attached thereto during manufacturing, such as by welding.

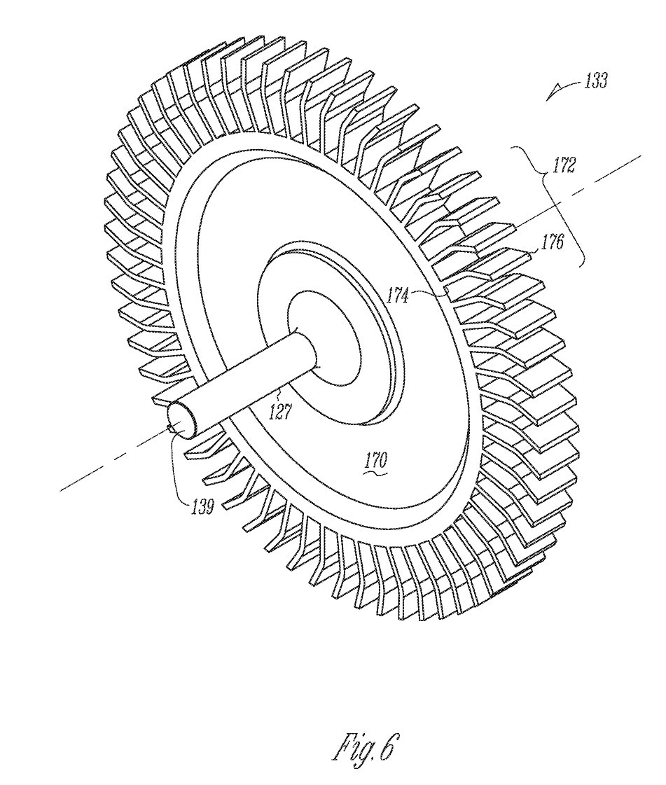

FIG. 7 is a perspective view of the regenerative blower 5A configured to be powered by an electric drive assembly 180. As illustrated in FIG. 7, the electric drive assembly 180 can include an engine 182, such as an internal combustion engine, an alternator 184, a battery pack 186 having one or more batteries 187, a motor controller 188, and an electric motor 190. In an example, the engine 182 can convert a liquid or gaseous fuel source into rotary motion of a power output shaft 191. The engine 182 can be the engine of a host vehicle in which the cleaning system is mounted, or a dedicated engine for the cleaning system. The alternator 184, which can include one or more belts 192, can covert the rotary motion of the engine 182 into electricity. The alternator 184 can include a regulation circuit to regulate the alternator output. The battery pack 186 can store the energy from the alternator 184 as chemical potential. Thus, the battery pack 186 can be configured to emit electric energy that can be used to drive the electric motor 190.

The electric motor 190 can convert the electric current from the battery pack 186 into rotary motion, which can be transmitted to the power input shaft 127 (not shown) of the regenerative blower 5A. In an example, the electric motor 190 can also be used to power other components, such as pumps, compressors, heating elements, or the like.

The motor controller 188 can be configured to condition and regulate the electric voltage and current into the components to which it supplies power, such as the electric motor 190. The motor controller 188 can also provide means to indirectly regulate the operational speed of the electric motor 190.

Although not shown, the electric drive assembly 180 can include various interconnecting and control devices. These interconnecting and control devices can include, for example, wires, switches, bulbs, overcurrent protection (such as fuses/breakers), and thermal protection.

The regenerative blower 5A is described and illustrated herein as a “single-stage” blower, wherein air molecules travel around the blower housing 120 a single time prior to being exhausted, merely for purposes of example. In various alternative examples, the regenerative blower 5A can be a “multi-stage” blower, such as a “two-stage” blower that can be configured to provide about twice the vacuum of a single-stage unit. Two-stage regenerative blowers can be configured to operate similar to a single-stage blower wherein an impeller can repeatedly strike the air molecules to create pressure and, consequently, the vacuum. However, in a two-stage blower, air molecules can make a first revolution around a front side impeller and, rather than being exhausted after the first revolution like the regenerative blower 5A, the air flow can be directed back to a rear side impeller through one or more channels provided in the blower housing. The redirected air molecules can then make a second revolution around the rear side impeller thereby doubling the number of times that impellers strike the air molecules. Once the air molecules have completed the second revolution around the rear side impeller, the air flow can be exhausted. Thus, two-stage blowers can be operable to provide higher pressures and vacuums because the impellers strike the air molecules over a period of two revolutions instead of just one as in a single-stage regenerative blower.

One benefit of the exemplary regenerative blower 5A in accordance with the present disclosure, compared to other blowers such as positive displacement pumps, can be that the blower requires minimal monitoring and maintenance. As discussed above, the impeller 133 is the only moving part in the regenerative blower 5A. Because the impeller 133 does not contact the blower housing 120 during rotation, the impeller 133 can be substantially wear-free. The first and second bearings 136 and 140, which can generally be self-lubricated, can be the only components that experience any significant wear over a long period of operation. Another benefit of the exemplary regenerative blower 5A can reside in the fact that the blower does not utilize oil, and also do not require a complicated intake and exhaust valve system. Because regenerative blowers are non-positive displacement devices, another benefit of the exemplary regenerative blower 5A can be the generation of discharge air that is generally “clean” and substantially pulsation-free.

Although the regenerative blower 5A is illustrated as being mounted with the impeller 133 in a plane generally perpendicular to the support frame 2, the regenerative blower 5A can alternatively be mounted in any plane. Regardless of the plane in which the regenerative blower 5A is mounted, the impeller 133 can be dynamically balanced such that minimal vibration is generated by the blower during operation. Additionally, although the regenerative blower 5A is described herein as including a single suction port 124 and a single discharge port 126, in various examples, multiple suction and discharge connection configurations can be utilized.

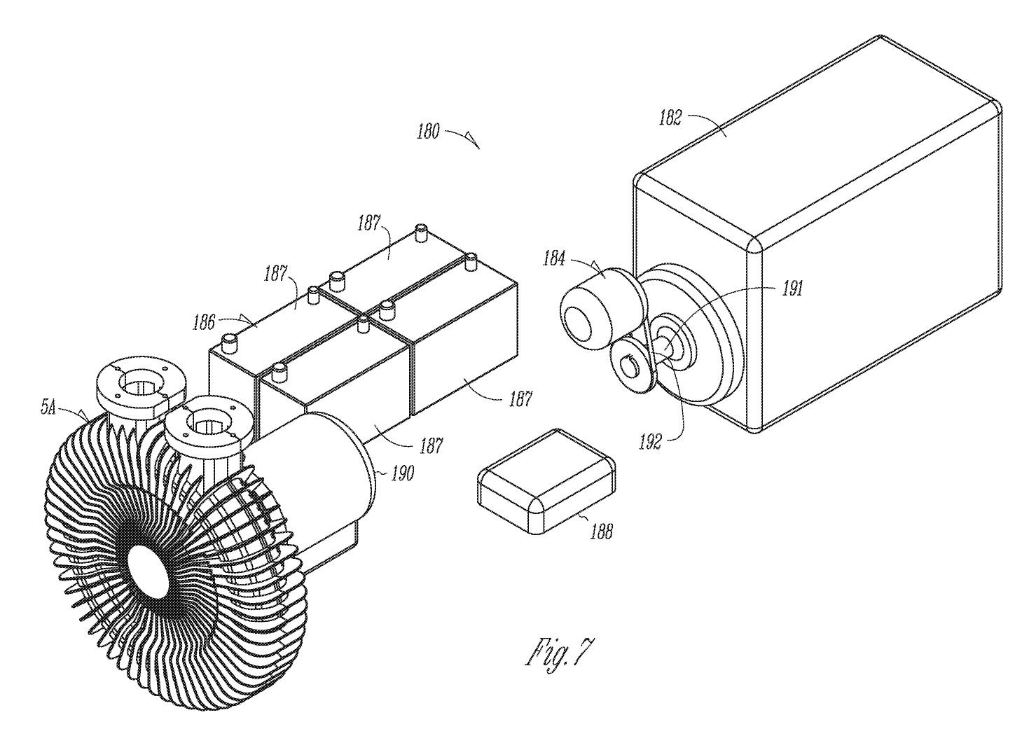

FIG. 8 is a diagrammatic illustration of truck 800 having slide-in cleaning system 801 configured for cleaning carpets, hard flooring, linoleum, and other surfaces. As illustrated in FIG. 8, cleaning system 801 can include structural platform or support frame 802 onto which various components can be mounted. In an example, cleaning system 801 can include drive system 803 mounted on support frame 802 and having power plant 804A coupled to receive fuel from an appropriate supply, air pump 805 that can operate as the vacuum source for removing soiled liquid (“gray water”) from the cleaned surface, and interface assembly 806 for transmitting power from power plant 804A to air pump 805. Power plant 804A can be, for example, any steam or internal combustion motor, such as a gasoline, diesel, alcohol, propane, or other fueled internal combustion engine. With further reference to FIG, 8, battery 807 can be provided as a source of electric energy for starting power plant 804A. Intake hose 808 can be coupled to a source of fresh water, and water pump 809 can be driven by power plant 804A via any suitable means, such as a V-belt or a direct drive, for pressurizing the fresh water.

As discussed above, in a vehicle-mounted system, blower 805 and pump 809 can be driven by the engine of the vehicle in which the cleaning system is mounted, such as power plant 804B of truck 800, rather than a separate, dedicated engine, such as power plant 804A.

One or more heat exchanger systems 810 can be coupled for receiving and heating the pressurized fresh water. Recovery tank 811, also referred to as a vacuum tank, can be provided for storing gray water after removal from the cleaned surface. High pressure solution hose 812 can be provided for delivering pressurized, hot water or a hot water and chemical solution from cleaning system 801 to a surface to be cleaned. In an example, chemical container 813 or other chemical system can be coupled for delivering a stream of cleaning chemical into the hot water as it enters high-pressure solution hose 812. At least one wand 814 can be coupled to high pressure solution hose 812 for receiving and dispersing the pressurized hot water or hot water and chemical cleaning solution to the surface to be cleaned. In various examples, two or more wands 814 can be provided, wherein each wand 814 is coupled to a dedicated high pressure solution hose 812. Wand 814 can be removed from the vehicle and carried to the carpet or other surface to be cleaned. Thus, in an example, wand 814 can be the only part of cleaning system 801 that is portable by an operator of system 801 during use, with all other components of cleaning system 801 remaining stationary within the vehicle during a cleaning operation. Wand 814 can be coupled via vacuum hose 815 to recovery tank 811, which can in turn be coupled to the high vacuum provided by air pump 805, for recovering the used cleaning solution from the cleaned surface and delivering it to recovery tank 811.

In an example, power plant 804A and air pump 805 of drive system 803 can be independently hard-mounted on support frame 802 either directly using one or more mechanical fasteners 816, or indirectly using one or more mounting plates or brackets 817. Water pump 809 can be mounted directly to power plant 804A, as shown, but can alternatively be mounted to support frame 802. Any suitable mechanical fasteners 816 can be used including, but not limited to, bolts, screws, or the like, Brackets 817 can be formed from any suitable material, such as metal. Support frame 802 can be configured for mounting in a van, truck or other suitable vehicle for portability, as illustrated in FIG. 8. In an example, Support frame 802 can be wheeled for portability independent of the vehicle, and can optionally be sized and structured to incorporate recovery tank 811.

Various types of interface assemblies 806 can be used for transmitting power from power plant 804A to air pump 805. One type of interface assembly that can be used for transmitting power from power plant 804A to air pump 805 is a rigid, direct drive coupling. Another type of interface assembly can include a belt drive system, which can be configured to transmit power through a series of pulleys and belts coupled to power plant 804A and air pump 805. In various examples, any other known interface assembly suitable for transferring rotational shaft power can be used.

Air pump 805 can be coupled via vacuum piping 818 for generating high vacuum in recovery tank 811, which can provide a suitable volume for carpet and other surface cleaning operations and can include baffles, filters, and/or other means for preventing gray or other water from entering air pump 805. Additionally, air pump 805 itself can be designed to be substantially impervious to water and debris ingestion. Recovery tank 811 can be mounted, for example, in the vehicle near drive system 803. An output of air pump 805 can be operably coupled, via exhaust piping 819, to heat exchanger system 810 for delivering exhaust gases to heat the pressurized water.

Cleaning system 801 can operate by delivering fresh water to n inlet of intake hose 108 utilizing, for example, a standard garden hose or a fresh-water container. The system can add energy to the fresh water, i.e., pressurize it, by means of pump 809. The fresh water can be pushed throughout the one or more heat exchanger systems 810 using pressure provided by pump 809. The one or more heat exchanger systems 810 can gain their heat by thermal energy rejected from air pump 805 or power plant 804A, e.g., from hot exhaust gasses, coolant water used on certain engines, or other suitable means. On demand from wand 814, pump 809 can drive the heated water through solution hose 812 where one or more cleaning chemicals can be added from chemical container 813, and then can deliver the water-based chemical cleaning solution to wand 814 for cleaning the floor, carpet or other surface. In one example, the hot water can travel, for example, between about fifty feet and about three-hundred feet to wand 814. The operator can deliver the hot solution via wand 814 to the surface to be cleaned, and can almost immediately extract the solution along with soil that has been emulsified by thermal energy or dissolved and divided by chemical energy. The extracted, soiled water can be drawn via vacuum hose 815 into recovery tank 811 for eventual disposal as gray water. An auxiliary pump (not shown), commonly referred to as an APO or Automatic Pump Out device, may be driven by power plant 804A for automatically pumping the gray water from recovery tank 811 into a sanitary sewer or other approved dumping location. Alternatively, this task can be performed manually.

The present disclosure is directed to an electric cleaning system that utilizes a power plant, such as power plant 804A or 804B, to mechanically drive an electrical generator, which can subsequently be used to provide electrical power to an electric motor that drives liquid pump 809 and air pump 805 or other air pumps, water pumps or blowers. Cooling fluid, such as a refrigerant circulated between power plant 80413 and radiator 820, can be used to cool the electrical generator and electric motor.

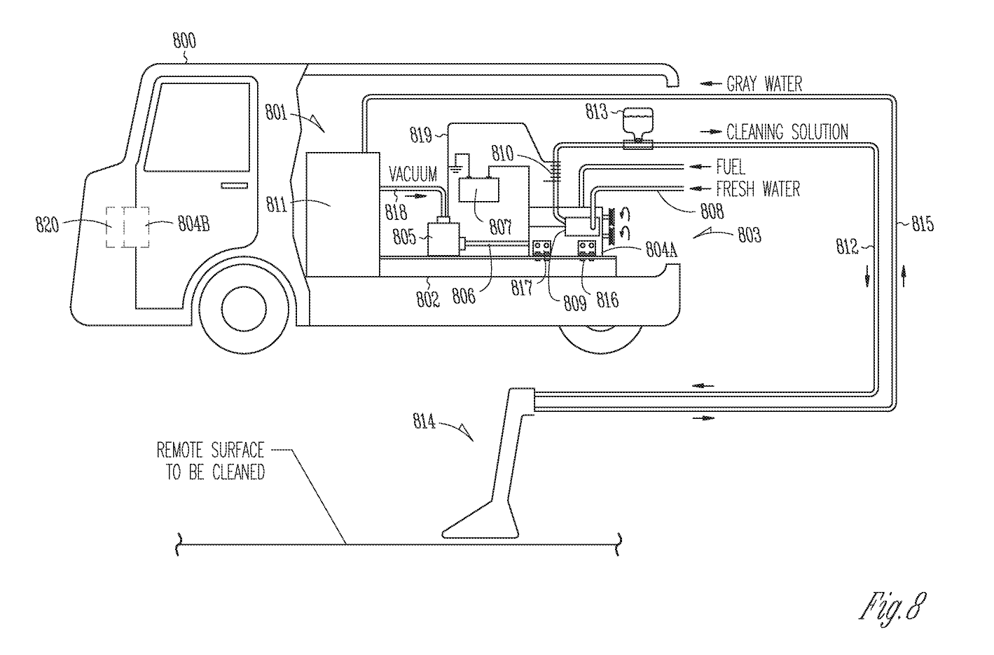

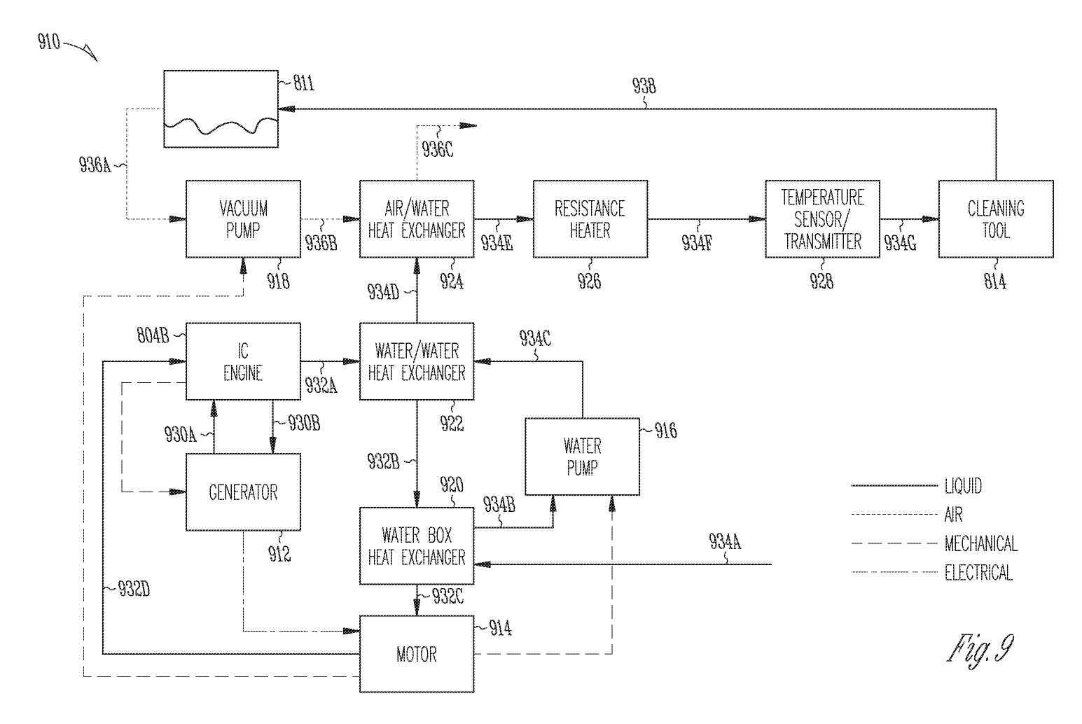

FIG. 9 is a schematic illustration of an electric carpet cleaning system 910 showing fluid and mechanical connections, in accordance with at least one example of the present disclosure. System 910 can be incorporated into a vehicle, such as van 800, as an alternative to a slide-in or truck-mounted cleaning system. Electric carpet cleaning system 910 can include generator 912, electric motor 914, water pump 916 and vacuum pump 918. System 910 can also include first heat exchanger 920, second heat exchanger 922 and third heat exchanger 924. System 910 can also include electric heater 926 and temperature sensor 928.

System 910 can operate under power from a prime mover, such as a vehicle engine similar to power plant 804B. System 910 can operate to provide heated water to and suction from a cleaning instrument, such as wand 814. System 910 can, however, be used with other power plants and cleaning instruments.

Generator 912 can be coupled directly to power plant 80413 such that mechanical output of power plant 804B is input into generator 912. In one example, rotational output of power plant 804B can be transferred to an input shaft of generator 912 via various means, such as belts, shafts and the like, as described above with reference to interface assemblies 806. Generator 912 can convert rotational input to electrical power, such as via a magneto-electric converter. Electricity produced by generator 912 can be transmitter to motor 914. Motor 914 can provide mechanical input to water pump 916 and vacuum pump 918. Water pump 916 can comprise any suitable pump as is conventionally known, such as positive displacement liquid pumps including reciprocating piston pumps, rotary pumps, gear pumps, screw pumps and the like. Vacuum pump 918 can comprise any suitable pump as is conventionally known, such as positive displacement air pumps, impellers, fans, blowers and the like.

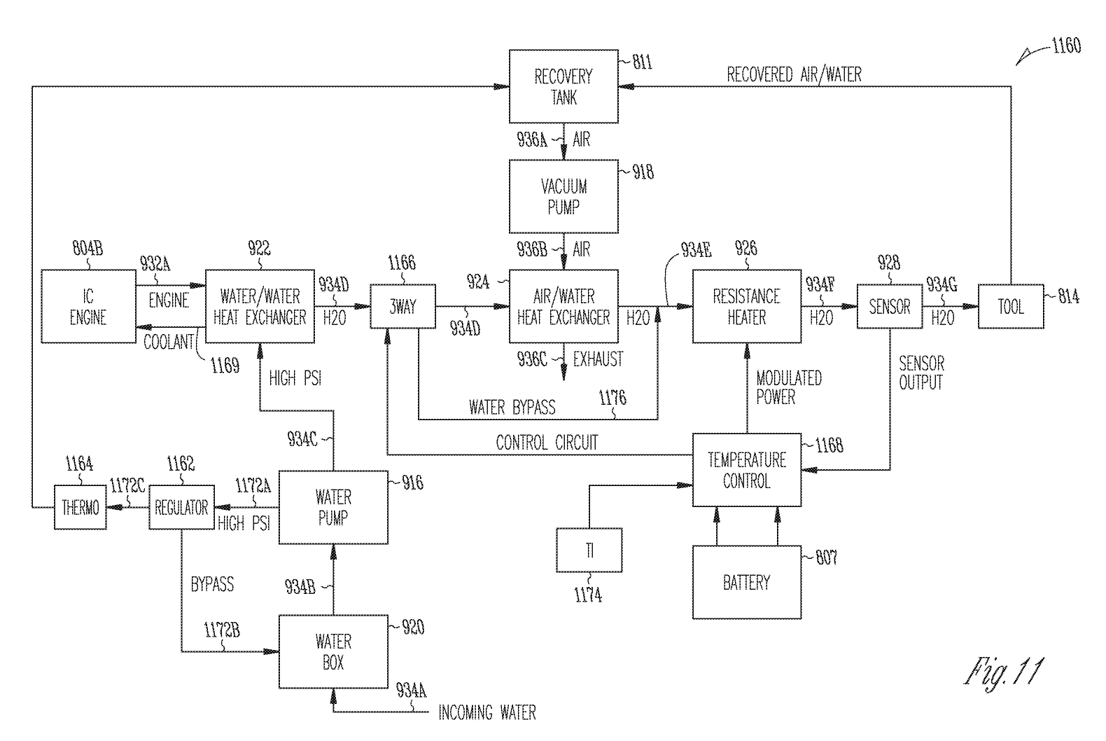

Power plant 804B can include a cooling system in which a cooling fluid, such as a coolant or refrigerant or water, is circulated to dump heat generated from the combustion in power plant 804B to the surrounding atmosphere using, for example, radiator 820 (FIG. 8). Cooling for generator 912 and motor 914 can be accomplished by running auxiliary engine coolant loops from power plant 804A through both generator 912 and motor 914 after being cooling in radiator 820, for example. Power plant cooling fluid diverted from power plant 804A can also be run through second heat exchanger 922 to first lower the temperature of the cooling fluid before being used to cool generator 912 and motor 914. If additional cooling is desired, the cooling fluid can also be directed through either a secondary liquid-to-liquid heat exchanger or an additional air-to-liquid heat exchanger in order to further reduce the temperature of the cooling fluid before it reaches motor 914 and generator 912. Temperature sensors inside both generator 912 and motor 914 can be used in conjunction with a system control, e.g. temperature control 1174 (FIG. 11), to control the flow of cooling fluid through the auxiliary engine coolant loops. Generator 912 can be connected into the cooling system using a first set of cooling lines 930A and 930B. For example, cooling line 930A can provide a cooled liquid to generator 912 and cooling line 930B can return the heated liquid to the cooling system for cooling, such as via radiator 820 that is air cooled.

First and second heat exchangers 920 and 922 can comprise liquid-to-liquid heat exchangers. Third heat exchanger 924 can comprise a liquid-to-air heat exchanger. In various examples, any suitable heat exchanger can be used, such as plate/fin heat exchangers or micro-channel heat exchangers.

Cooling fluid from the cooling system of power plant 804B can also be circulated through a second system of cooling lines 932A-932D. Cooling fluid heated in power plant 80413 can be provided to second heat exchanger 922 via line 932A, then to first heat exchanger 920 via line 932B. As such, as explained below, heat from power plant 804B can be input into liquid used to clean in conjunction with wand 814. As such, the cooling fluid is lowered in temperature and can be used to cool motor 914 via line 932C. After cooling motor 914 the fluid can be returned to the cooling system of power plant 804B via line 932D.

Low pressure water, which can typically be cold water, is provided to first heat exchanger 920 via water line 934A. First heat exchanger 930 can be used in conjunction with a water storage container, or water box, that is used to bring clean water into system 910. As discussed below with reference to FIG. 11, a stand-alone water box can be used without a heat exchanger. Thus, within first heat exchanger 920, cold water can be imparted with heat from cooling fluid of the cooling system of power plant 804B. From first heat exchanger 920 the warmed water flows into water pump 916 via water line 34B. For example, water can be drawn into water pump 916 via pressure generated by pump 916. High pressure warmed water generated by water pump 916 can be provided to second heat exchanger 922 via water line 934C. Within second heat exchanger 922, high pressure warmed water can be further heated by cooling fluid directly leaving power plant 804B. As such, hot water can be provided to third heat exchanger 924 via water line 34D.

Under pressure from water pump 916, the hot water can flow from third heat exchanger 924 to resistance heater 92.6 via water line 934E, then to temperature sensor 928 via line 934F and then to wand 814 via line 34G.

Hot water provided to third heat exchanger 924 can be further heated by hot exhaust air from vacuum pump 918. Vacuum pump 918 can draw in cool air from air line 36A, which may or may not be configured to draw air from recovery tank 811, and pressurizes the air, thereby heating the air. In one example, air line 936A is connected to recovery tank 811 to provide the suction to wand 814. The heated air can be provided to third heat exchanger 924 via air line 936B. Thus, heat from the air can be imparted to hot water within third heat exchanger 924. The cooled air can be dumped to the atmosphere via air line 936C.

Resistance heater 926, or another electrically activated heater, can be further used to heat the water just before wand 814. Resistance heater 926 can be selectively operated, as discussed below with reference to FIG. 11, in order to provide precise temperature control at the surface to be cleaned, thereby eliminating or reducing wide temperature variations that may arise due to mechanical temperature control means.

Hot water can thereby be provided to wand 814 to perform cleaning of a surface, such as carpet. Dirty, gray water is drawn from the cleaning surface via suction line 938, which, using the vacuum generated by vacuum pump 918, pulls the water into recovery tank 811. The dirty water can be trapped and stored within recovery tank 811, while cold air is drawn from recovery tank 811 into vacuum pump 918.

System 910 provides a more overall efficient system for cleaning surfaces. Power plant 804B can be can be operated at one continuous speed, maintaining optimal efficiency level for power plant 804B, rather than as is dictated by the demands of system 910. Electric generator 912 can also be ran at one continuous speed during surface cleaning operation, thereby maintaining optimal electrical efficiency. Electric generator 912 can be capable of operating within the entire revolutions per minute (RPM) range of power plant 80413, thereby eliminating the need to decouple generator 912 from power plant 804B during normal driving conditions,

Furthermore, removal of the mechanical connection between the drive components (e.g. power plant 804B) and the driven components (e.g. water pump 916 and vacuum pump 918) eliminates rotating equipment (e.g. clutches, shafts, bearings, universal joints) that have a limited service life and require maintenance. It also reduces the modification required to the host vehicle structure, such as van 800.

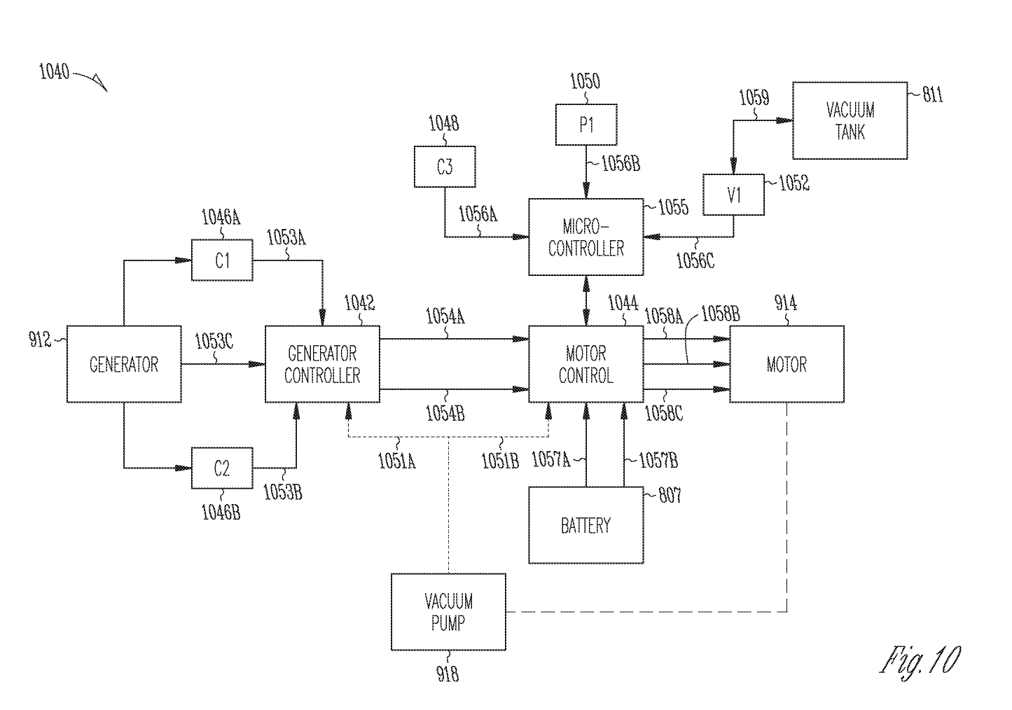

Additionally, system 910 allows for efficient and accurate control of air flow, air pressure and water temperature within system 910 using electric and thermal control systems, such as those discussed with reference to FIGS. 10-12.

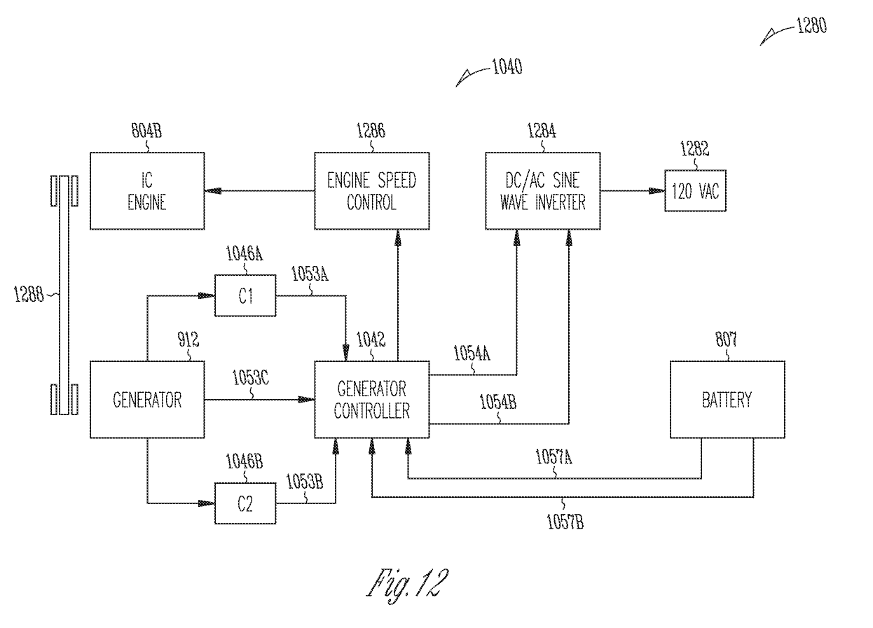

FIG. 10 is a schematic illustration of electrical system 1040 for electric carpet cleaning system 910 of FIG. 9. In a base example, electrical system 1040 can include generator 912, battery 807, generator control 1042, first contactor 1046A, and second contactor 1046B. Such a base configuration can be used to provide electric power to a variety of systems, such as a carpet and floor cleaning system. In such an example, electrical system 1040 can further include components to drive an electric motor, such as motor 914, motor controller 1044, flow control 1048, pressure control 1050 and vacuum sensor 1052. In other examples, electrical system 1040 can be used to provide electric power to other systems, as is described below with reference to FIG. 12.

Generator 912 can comprise a three-phase, alternating current (AC) generator, as is known in the art. In one example, generator 912 can have an 18 KW rating/capacity, The three different electrical currents produced by generator 912 can be connected to generator control 1042 via power lines 1053A, 1053B and 1053C, Contactors 1046A and 1046B can be connected into power lines 1053A and 1053B to provide shut-offs to current running therethrough. Contactors 1046A and 1046B can act as a safety mechanism to cut power to generator control 1042 and can thus be connected to motor control 1044 to be automatically opened under threshold conditions. In another example, contactors 1046A and 1046B can be manually opened. Generator control 1042 can effectively operate with fixed input from generator 912 or with variable output of generator 912, depending on, for example, the operating conditions of power plant 804B in order to provide continuous output to motor control 1044. Generator control 1042 can convert the three-phase power of generator 912 into direct current (DC). In one example, generator control 1042 comprises an AC-to-DC converter, as is known in the art. As such, positive and negative terminals 1054A and 1054B can be connected to motor control 1044.

Motor control 1044 can receive various inputs of system 1040 and make adjustments to the operation of motor 914 in response thereto. In one example, motor control 1044 is coupled to micro-controller 1055 that receives inputs from flow control 1048, pressure control 1050 and vacuum sensor 1052 through control lines 1056A, 1056B and 1056C, respectively. Micro-controller 1055 can condition and convert raw signals from flow control 1048, pressure control 1050 and pressure sensor 1052 into signals useable by motor control 1044. In one example, motor control 1044 and micro-controller comprise any suitable devices as are known in the art. Motor control 1044 and micro-controller 1055 can be powered by battery 807, such as by connection of positive and negative terminals 1057A and 1057B to motor control 1044. In another example, motor control 1044 and micro-controller 1055 can be powered by the electrical system of van 800. Motor control 1044 can provide three-phase power to motor 914 via power lines 1058A, 1058B and 1058C. In one example, motor 914 can have an 18 kW rating/capacity, and can comprise any suitable motor as is known in the art, such as a magneto-electric motor.

Generator control 1042 and motor control 1044, as well as micro-controller 1055, can be actively cooled by use of air flow created by vacuum pump 918. Air recovered from the cleaning process, such as air in line 936A of FIG. 9, can be directed into air lines 1051A and 1051B and then past one or more heat sinks (not shown) attached to the controllers to provide a desirable cooling effect for full power operation. In one example, the heat sinks can be integrated into recovery tank 811 such that generator control 1042, motor control 1044 and micro-controller 1055 are mounted on or in close proximity to recovery tank 811.

Flow control 1048 can comprise an operator-adjustment that can be located on wand 814. Flow control 1048 allows the operator to adjust the volumetric flow rate, e.g. cubic feet per minute, of air through wand 814. Flow control 1048 can adjust the voltage provided to motor 914 by motor control 1044 via power lines 1058A, 105813 and 1058C to control the speed of motor 914, which thereby adjusts the speed of vacuum pump 918. Flow control 1048 can control the minimum amount of airflow through wand 814 by setting the minimum speed of motor 914.

Pressure control 1050 can comprise an operator-adjustment that can be located on wand 814. Pressure control 1050 allows the operator to adjust the air pressure generated by system 910. For example, system 910 may operate to generate a default suction pressure at wand 814. However, it can be desirable for an operator to use a lower pressure when cleaning delicate materials. Pressure control 1048 can adjust the voltage provided to motor 914 by motor control 1044 via power lines 1058A, 1058B and 1058C to control the speed of motor 914, which thereby adjusts the speed of vacuum pump 918. Pressure control 1048 can control the maximum air pressure at wand 814 by setting the maximum speed of motor 914.

Pressure sensor 1052 can be positioned on recovery tank 811 or vacuum line 1059 extending therefrom. In another example, pressure sensor 1052 can be placed in suction line 1038 or air line 1036A. Pressure sensor 1052 provides a pressure signal to micro-controller 1055 that is used in determining the appropriate speed of motor 914 based on inputs from flow control 1048 and pressure control 1050. Micro-controller 1055 can include programming or logic to control motor 914. For example, if pressure control 1050 sets the maximum value of pressure in system 1040, motor control 1044 can take a reading from pressure sensor 1052 to determine if the actual pressure needs to be increased or decreased, and subsequently issue a corresponding control signal to motor 914 to increase or decrease motor speed.

With the electric cleaning system described herein, operator controls are provided that allow the operator to choose the appropriate air flow and vacuum pressure for a particular cleaning operation without changing the speed of power plant 804B of truck 800. By driving positive displacement vacuum pump 918 with electric motor 914, the airflow pressure and volume can be controlled by setting the speed of vacuum pump 918, which can be precisely controlled by electronic speed feedback provided by flow control 1048 and pressure control 1050 that can send signals to motor control 1044 to precisely control the speed of vacuum pump 918 in conjunction with input from pressure sensor 1052. This eliminates the need for a mechanical vacuum relief valve that wastes energy. Further, the operator can continue to operate want 814 while making system adjustments and the operator does not have to return to van 800 to adjust mechanical system components to make air and temperature adjustments.

FIG. 11 is a schematic illustration of temperature control circuit 1160 for electric cleaning system 910 of FIG. 9. Temperature control circuit 1160 includes water pump 916, vacuum pump 918, a water box of first heat exchanger 920, second heat exchanger 922, third heat exchanger 924, resistance hater 916 and sensor 928, as discussed above. Temperature control circuit 1160 also includes regulator 1162, thermo valve 1164, 3-way valve 1166 and temperature control 1168.

In the example of FIG. 11, the water box of heat exchanger 920 is not coupled to coolant from power plant 804B, as is shown in FIG. 9. As such, temperature control circuit 1160 provides heating to system water only at heat exchanger 922, heat exchanger 924 and heater 926. As such, power plant 80413 can provide hot coolant to second heat exchanger 922 via line 932A. However, rather than continuing through lines 93413 9341) as shown in FIG. 9, the coolant can be directly returned to power plant 804B via line 1169. However, as discussed above, coolant from power plant 804B can be used to cool other devices of system 1040, including electric generator 912 and electric motor 914.

The water box of heat exchanger 920 and water pump 916 can be connected into regulator loop 1170, which can include regulator 1162 and thermos valve 1164. Regulator 1162 can comprise any suitable device as is known in the art that allows excess capacity of water pump 916 to be drawn off of the output of water pump 916 without affecting the pressure generated by water pump 916. As such, water pump 916 can continuously run regardless of whether water is being dispensed by wand 814. Regulator 1162 can receive high pressure water from water pump 916 at line 1172A and return high pressure water to the water box of heat exchanger 920 at line 1172B. As such, water pump 916 can continue to pressurize and pump water no matter how much water is being drawn at wand 814. Furthermore, regulator 1162 can be connected to thermo valve 1164 via line 11721. Thermo valve 1164 can be configured to open if water in regulator loop 1170 reaches a threshold temperature level. For example, even if wand 814 is operating to dispense water, a certain amount of water can continue to re-circulate in regulator loop 1170, thereby rising in temperature due to, among other things, the mechanical compression process. Thus, thenno valve 1164 can open to dump hot water trapped in regulator loop 1170 to recovery tank 811. This subsequently can cause new, cold water to be admitted into the water box of heat exchanger 920, which can include a level sensor and/or a level valve to admit water based on the level of water in the water box of heat exchanger 920.

Water from water pump 916 can continue to second heat exchanger 922 via line 934C where it is, in the example of FIG. 11, first heated be coolant from power plant 804B. The heated water continues into third heat exchanger 924 via line 934D after passing through 3-way valve 1166. 3-way valve 1166 can comprise an actively controlled valve that is opened based on temperatures sensed by temperature sensor 928. For example, output from sensor 928 can be provided to temperature control 1168, which can then compare the sensed temperature to temperature input 1174 set by an operator of system 1160. When the temperature sensed by sensor 928 exceeds the operator-specified level, temperature control 1168 can send a signal to 3-way valve 1166 that causes valve 1166 to open and route water around third heat exchanger 924 through bypass line 1176 to line 934E, where it flows into resistance heater 926.

When water is not flowing through bypass line 1176, third heat exchanger 924 operates to heat the water using heated exhaust gas from vacuum pump 918. Temperature control 1168 coordinates operation of resistance heater 926 and 3-way valve 1166 in conjunction with operation of second heat exchanger 922 to maintain water at the level specified by the operator, such as at temperature input 1174.

In both the examples of FIG. 8 and FIG. 11, water can be heated for the cleaning process in three zones in order to effectively utilize each available heat source. The first zone can use heat from power plant 804B. The second zone can use heat from vacuum pump 918. The third zone can use heat from resistance heater 926.

The first zone can use heat from the combustion process within power plant 804B that is transferred to a coolant of the cooling system of power plant 804B. The coolant can be put into thermal communication with the water through the use of various liquid-to-liquid heat exchangers, such as first heat exchanger 920 or second heat exchanger 922. This is the highest volume heat source, but the lowest grade heat source available. The highest percentage of heat load comes from this source. This zone is not actively controlled, except by the thermostat in the vehicle engine.

The second zone can use heat from compressed air exhausted from vacuum pump 918. The compressed air is elevated in temperature during the compression process. The air can be put into thermal communication with the water through the use of various air-to-liquid heat exchangers, such as third heat exchanger 924. This zone can be actively controlled by the use of a recirculation loop comprising bypass line 1176 that bypasses third heat exchanger 924 using 3-way valve 1166 and temperature sensor 928. The second zone can also be passively controlled using a mechanical temperature limit device and heat bank. A recirculation loop can be formed between the third heat exchanger and the heat bank such that hot exhaust air can be put into heat transfer with the recirculation loop, rather than directly with the water. In other words, the hot air can transfer heat to the heat bank, the heat bank can transfer heat to the recirculation loop, and the recirculation loop can transfer heat to the water. The temperature of the heat bank can be controlled using the mechanical temperature limit device to prevent the heat bank from exceeding a predetermined temperature level. As such, the amount of heat from the hot exhaust gas imparted into the water can be passively limited by mechanical means.

The third heating zone is comprised of resistance heater 926 and is used to precisely control the temperature of the water at wand 814 as the water engages the heating surface. A hose forming line 934F and 934G can be embedded with one or more resistance heating elements that allow the water being flowed inside the hose to be heated on its way to wand 814 and the cleaning surface. In another example, one or more resistance heating elements can be mounted within the housing of the carpet cleaning machine at wand 814. At wand 814, temperature sensor 928 reads the water temperature and transmits that reading back to temperature control 1168. In one example, temperature sensor 928 can include a radio transmitter that can communicate with temperature control 1168. In another example, temperature sensor 928 can be connected to temperature control via wiring. In an example, temperature sensor 928 can be located at the end of line 934G attached to wand 814.

FIG. 12 is a schematic illustration of electrical system 1040 of FIG. 10 configured to have A/C voltage output 1280. Electrical system 1040 can include generator 912, battery 807, generator control 1042, first contactor 1046A, and second contactor 1046B, as discussed above. However, rather than being configured to generate three-phase AC electrical power to drive an electric motor, electrical system 1040 can be configured to provide DC output at DC voltage bus 1282 using inverter 1284 and engine speed control 1286. As such, electric system 1040 can be installed within truck 800 or any other vehicle having a power plant, such as an internal combustion engine, to generate DC output for powering auxiliary systems of the vehicle or installed in the vehicle. For example, electrical system 1040 can be used to provide power to communications technology, such as for use in television and radio broadcast news vehicles, or police, fire and military command centers.

Power plant 804A can operate to provide rotational input to electric generator 912, such as by use of belt 1288. However, other suitable power transfer devices may he used. In one example, power plant 804A comprises a typical internal combustion engine as is found in a light duty vehicle. In one example, electric generator 912 can comprise a permanent magnet synchronous generator. Three-phase AC power generated by generator 912 can be transmitted to generator control 1042 via power lines 1053A-1053C, with contactors 1046A and 1046B being provided to inhibit power transmission therebetween, as discussed above. Generator control 1042 can produce DC power that can be provided via terminals 1054A and 1054B to inverter 1284, which produces DC voltage at DC voltage bus 1282. Inverter 1284 may comprise any suitable DCAC inverter as is known in the art, such as a sine wave inverter.

Battery 807 can provide power to generator control 1042 via terminals 1057A and 1057B. Generator control 1042 can also be in electronic communication with engine speed control 1286. Power plant 804B can be controlled by engine speed control 1286 and can provide direct mechanical power to electric generator 912. The speed of power plant 80413 can be regulated by generator control 1042 based on load induced on DC voltage bus 1282. Varying the speed of power plant 804B based on load can result in reduced overall fuel consumption and wear on power plant 804B.

AC voltage is produced by taking the DC bus voltage output from generator control 1042 and running that voltage output through a sine wave inverter to produce AC output. Since generator control 1042 regulates the DC power bus independent of the AC voltage and frequency produced by generator 912, the speed of generator 912 is not a limiting factor as is the case in some other conventional AC generators. This allows the speed of power plant 80413 to vary, while electric system 1040 still outputs a steady AC voltage output from inverter 1284.

As discussed herein, electrical system 1040 can be advantageously used in vehicle installed cleaning systems to reduce wear on the vehicle, improve control over the cleaning system air pressure, air volume and water temperature, and improve the user convenience of operating the system.

The above Detailed Description includes references to the accompanying drawings, which form a part of the detailed description. The drawings show, by way of illustration, specific embodiments in which the invention can be practiced. These embodiments are also referred to herein as “examples,” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1.-20. (canceled)

21. A vehicle power system for providing input to an auxiliary fluid system, comprising:
a vehicle-mounted power plant;
a generator mechanically coupled to the power plant;
a motor electrically coupled to the generator to provide mechanical output; and
a component of the auxiliary fluid system configured to receive the mechanical output of the motor.

22. The vehicle power system of claim 21, wherein the component comprises a pump.

23. The vehicle power system of clai , wherein the component comprises a blower.

24. The vehicle power system of claim 21, wherein the component comprises a compressor.

25. The vehicle power syster r of claim 21, wherein the component comprises a heating element.

26. The vehicle power system of claim 21, wherein th auxiliary fluid system includes a cleaning tool fluidly coupled to the component.

27. The vehicle power system of claim 26, wherein the auxiliary fluid system further comprises:
a liquid pump configured for generating pressurized liquid; and
an air blower configured for generating pressurized air;
wherein the cleaning tool is fluidly coupled to a liquid pump outlet and an air blower inlet.

28. The vehicle power system of claim 27, wherein the component comprises an input shaft integral with an impeller of the air blower.

29. The vehicle power system of claim 27, further comprising a liquid-to-air heat exchanger configured to exchange heat from discharge air of the air blower and discharge liquid of the liquid pump.

30. The vehicle power system of claim , wherein the motor is electrically coupled to the generator via a battery.

31. The vehicle power system of claim 21, wherein the generator comprises an alternator coupled to the vehicle-mounted power plant via a belt

32. The vehicle power system of claim 21, further comprising a motor controller for regulating electric voltage and current of the component.

33. The vehicle power system of claim 21, wherein the vehicle-mounted power plant comprises an engine of a vehicle in which the vehicle power system is used.

34. A vehicle power system for providing input to a vehicle-mounted cleaning system, comprising:
an engine of a vehicle in which the cleaning system is mounted;
a generator mechanically coupled to the engine;
a motor electrically coupled to the generator to provide mechanical output; and
a fluid pressurizing device for the cleaning system that is configured to receive the mechanical output of the motor.

35. The vehicle power system of claim 34, further comprising a motor controller for regulating electric voltage and current of the fluid pressurizing device.

36. The vehicle power system of claim 34, wherein the motor is electrically coupled to the generator via a battery.

37. The vehicle power system of claim 34, wherein the fluid pressurizing device is fluidly coupled to a cleaning wand of the cleaning system.

38. The vehicle power system of claim 37, wherein the cleaning system further comprises:
a liquid pump configured for generating pressurized liquid;
wherein the fluid pressurizing device comprises an air blower configured for generating pressurized air; and
wherein the cleaning wand is fluidly coupled to a liquid pump outlet and an air blower inlet.

39. The vehicle power system of claim 38, further comprising a liquid-to-air heat exchanger configured to exchange heat from discharge air of the air blower and discharge liquid of the liquid pump.

40. The vehicle power system of claim 34, wherein the fluid pressurizing device comprises a regenerative blower.
